(19) United States
(12) Patent Application Publication
(10) Pub. No.: US 2025/0070187 A1
(43) Pub. Date: Feb. 27, 2025

(54) ANODES FOR LITHIUM-BASED ENERGY STORAGE DEVICES

(71) Applicant: GRAPHENIX DEVELOPMENT, INC., Williamsville, NY (US)

(72) Inventors: Alexander J. Warren, Williamsville, NY (US); Peter Symons, Williamsville, NY (US); John C. Brewer, Williamsville, NY (US); Kyle P. Povlock, Williamsville, NY (US); Kevin Tanzil, Williamsville, NY (US); Robert G. Anstey, Williamsville, NY (US)

(73) Assignee: GRAPHENIX DEVELOPMENT, INC., Williamsville, NY (US)

(21) Appl. No.: 18/723,701

(22) PCT Filed: Dec. 19, 2022
(86) PCT No.: PCT/US2022/053321

§ 371 Date: Jun. 24, 2024

Related U.S. Application Data
(60) Provisional application No. 63/294,159, filed on Dec. 28, 2021.

(51) Int. Cl. H01M 4/66; H01M 4/02; H01M 4/04; H01M 4/62; H01M 10/0525; H01M 10/42

(52) U.S. Cl. CPC H01M 4/667; H01M 4/0404; H01M 4/625; H01M 4/661; H01M 10/0525; H01M 10/42; H01M 2004/027

(57) ABSTRACT

An anode for an energy storage device includes a current collector having an electrically conductive layer and a surface layer disposed over and in contact with the electrically conductive layer. The surface layer may include a transition metallate other than chromate. A lithium storage layer overlays and is in contact with the surface layer. The lithium storage layer may have an average thickness of at least 1 μm, includes at least 40 atomic % silicon, germanium, or a combination thereof, and is substantially free of carbon-based binders. The lithium storage layer may be a continuous porous lithium storage layer.

### CROSS-REFERENCE TO RELATED APPLICATIONS

This application claims priority to, and any other benefit of, U.S. Provisional Patent Application Ser. No. 63/294,159, entitled “ANODES FOR LITHIUM-BASED ENERGY STORAGE DEVICES,” filed Dec. 28, 2021, the entire disclosure of which is fully incorporated herein by reference for all purposes.

### TECHNICAL FIELD

The present disclosure relates to lithium-ion batteries and related energy storage devices.

### BACKGROUND

Silicon has been proposed for lithium-ion batteries to replace the conventional carbon-based anodes, which have a storage capacity that is limited to ˜370 mAh/g. Silicon readily alloys with lithium and has a much higher theoretical storage capacity (˜3600 to 4200 mAh/g at room temperature) than carbon anodes. However, insertion and extraction of lithium into the silicon matrix causes significant volume expansion (>300%) and contraction. This can result in rapid pulverization of the silicon into small particles and electrical disconnection from the current collector.

The industry has recently turned its attention to nano- or micro-structured silicon to reduce the pulverization problem, i.e., silicon in the form of spaced apart nano- or micro-wires, tubes, pillars, particles, and the like. The theory is that making the structures nano-sized avoids crack propagation and spacing them apart allows more room for volume expansion, thereby enabling the silicon to absorb lithium with reduced stresses and improved stability compared to, for example, macroscopic layers of bulk silicon.

Despite research into various approaches, batteries based primarily on silicon have yet to make a large market impact due to unresolved problems.

### SUMMARY

There remains a desire for anodes for lithium-based energy storage devices such as Li-ion batteries that are easy to manufacture, robust to handling, high in charge capacity amenable to fast charging, for example, at least 1 C, and have good cycle life.

In accordance with an embodiment of this disclosure, an anode for an energy storage device includes a current collector having an electrically conductive layer and a surface layer disposed over and in contact with the electrically conductive layer. The surface layer may include a transition metallate other than chromate. A lithium storage layer overlays and is in contact with the surface layer. The lithium storage layer may have an average thickness of at least 1 μm, includes at least 40 atomic % silicon, germanium, or a combination thereof, and is substantially free of carbon-based binders. The lithium storage layer may be a continuous porous lithium storage layer.

In accordance with another embodiment of this disclosure, a method of making an anode for use in an energy storage device is provided. The method may include providing a current collector having an electrically conductive layer and a surface layer overlaying and in contact with the electrically conductive layer. The surface layer may include, or is formed from, a transition metallate other than chromate. A lithium storage layer is deposited onto the surface layer by a vapor deposition process. The lithium storage layer has an average thickness of at least 1 μm, includes at least 40 atomic % silicon, germanium, or a combination thereof, and is in contact with the surface layer. The vapor deposition process may be a PECVD process.

In accordance with another embodiment of this disclosure, a method of making a current collector for use in an energy storage device is provided. The current collector may include an electrically conductive layer and a surface layer. The method includes forming the surface layer on the electrically conductive layer by contacting the electrically conductive layer with a mixture comprising a transition metallate compound other than a chromate and one or more mixture solvents. The current collector is characterized by a surface roughness Ra≥250 nm, and the mixture is substantially free of a silicon compound.

In accordance with another embodiment of this disclosure, an anode for an energy storage device may include a current collector made according to methods of the present disclosure.

In accordance with another embodiment of this disclosure, a lithium-ion battery is provided that may include an anode of the present disclosure.

The present disclosure provides anodes for energy storage devices that may have one or more of at least the following advantages relative to conventional anodes: improved stability at aggressive≥1 C charging and/or discharging rates; higher overall areal charge capacity; higher charge capacity per gram of lithium storage material (e.g., silicon); improved physical durability; simplified manufacturing process; more reproducible manufacturing process; reduced environmental impact manufacturing process, or reduced dimensional changes during operation.

### BRIEF DESCRIPTION OF DRAWINGS

FIG. 1 is a cross-sectional view of a non-limiting example of an anode according to some embodiments.

FIG. 2 is a cross-sectional view of a prior art anode.

FIG. 3 is a cross-sectional view of a non-limiting example of an anode according to some embodiments.

FIG. 4 is a cross-sectional view of a non-limiting example of an anode according to some embodiments.

FIG. 5A is a cross-sectional schematic view of a non-limiting example of a current collector having first-type nanopillars according to some embodiments.

FIG. 5B is a cross-sectional schematic view of a non-limiting example of a current collector having second-type nanopillars according to some embodiments.

FIG. 6A is an SEM cross-sectional view of a non-limiting example of a current collector having nanopillar or nodular roughening features according to some embodiments.

FIG. 6B is an SEM cross-sectional view of a non-limiting example of a current collector having nanopillar or nodular roughening features according to some embodiments.

FIG. 7 is an SEM cross-sectional view of a non-limiting example of a current collector having broad roughness features according to some embodiments.

FIG. 8 is an SEM of a non-limiting example of a surface of a current collector that has been chemically roughened according to some embodiments.

FIG. 9. is an SEM of a non-limiting example of a current collector having nanopillar or nodular roughening features according to some embodiments.

FIG. 10. is an SEM of Copper Foil C.

FIG. 11 is an SEM of the current collector of Example Anode E-3 prior to silicon deposition.

FIG. 12 is an SEM of the current collector of Example Anode E-11 prior to silicon deposition.

### DETAILED DESCRIPTION

It is to be understood that the drawings are for purposes of illustrating the concepts of the disclosure and may not be to scale. Terms like “overlaying”, “over” or the like include, but do not necessarily require, direct contact (unless such direct contact is noted or clearly required for functionality). Herein, an “average” may represent a mean, median, or mode, and an “average thickness” may be based on at least three measurements (e.g., 3, 4, 5, 6, 7, 8, 9, 10, or more measurements). Additional details of certain embodiments of the present application may be found in U.S. Pat. Nos. 10,910,653, 11,024,842, U.S. Application Publication No. 2021/0050584, U.S. Application Publication No. 2021/0057733, U.S. Application Publication No. 2021/0057757, U.S. Application Publication No. 2021/0057755, U.S. Application Publication No. 2021/0066702, PCT International Publication Number WO2022/005999, PCT Application No. PCT/US2021/064018, and U.S. patent application Ser. No. 17/526,055, the entire contents of which are incorporated herein by reference for all uses.

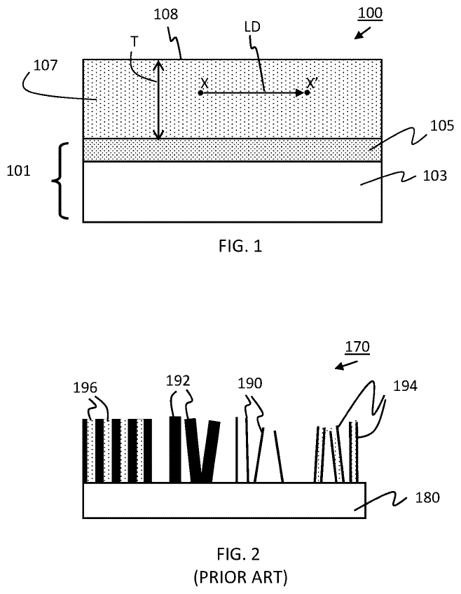

FIG. 1 is a cross-sectional view of an anode according to some embodiments of the present disclosure. Anode 100 includes current collector 101 and a lithium storage layer 107 overlaying the current collector. In some embodiments, the lithium storage layer may be a continuous porous lithium storage later as described elsewhere herein. Current collector 101 includes a surface layer 105 provided over an electrically conductive layer 103, for example an electrically conductive metal layer. Although the figure shows the surface of the current collector as flat for convenience, the current collector may have a rough surface as discussed below. The lithium storage layer 107 is provided over surface layer 105. In some embodiments, the top of the continuous porous lithium storage layer 107 corresponds to a top surface 108 of anode 100. In some embodiments the lithium storage layer 107 is in physical contact with the surface layer 105. In some embodiments the continuous porous lithium storage layer includes a material capable of forming an electrochemically reversible alloy with lithium. In some embodiments, the continuous porous lithium storage layer includes silicon, germanium, tin, or alloys thereof. In some embodiments the lithium storage layer includes at least 40 atomic % silicon, germanium, or a combination thereof. In some embodiments, the lithium storage layer is provided by a physical vapor deposition (PVD) process, e.g., by sputtering or e-beam, or by a chemical vapor deposition (CVD) process including, but not limited to, hot-wire CVD or a plasma-enhanced chemical vapor deposition (PECVD).

In the present disclosure, the lithium storage layer 107, such as a continuous porous lithium storage layer, may be substantially free of high aspect ratio nanostructures, e.g., in the form of spaced-apart wires, pillars, tubes or the like, or in the form of regular, linear vertical channels extending through the lithium storage layer. FIG. 2 shows a cross-sectional view of a prior art anode 170 that includes some non-limiting examples of lithium storage nanostructures, such as nanowires 190, nanopillars 192, nanotubes 194 and nanochannels 196 provided over a current collector 180. Unless noted otherwise, the term “lithium storage nanostructure” herein generally refers to a lithium storage active material structure (for example, a structure of silicon, germanium or their alloys) having at least one cross-sectional dimension that is less than about 2,000 nm, other than a dimension approximately normal to an underlying substrate (such as a layer thickness) and excluding dimensions caused by random pores and channels. Similarly, the terms “nanowires”, “nanopillars” and “nanotubes” refers to wires, pillars and tubes, respectively, at least a portion of which, have a diameter of less than 2,000 nm. “High aspect ratio” nanostructures have an aspect ratio greater than 4:1, where the aspect ratio is generally the height or length of a feature (which may be measured along a feature axis aligned at an angle of 45 to 90 degrees relative to the underlying current collector surface) divided by the width of the feature (which may be measured generally orthogonal to the feature axis). In some embodiments, the lithium storage layer, e.g., a continuous porous lithium storage layer, is considered “substantially free” of lithium storage nanostructures when the anode has an average (e.g., mean, median, or mode) of fewer than 10 lithium storage nanostructures per 1600 square micrometers (in which the number of lithium storage nanostructures is the sum of the number of nanowires, nanopillars, and nanotubes in the same unit area), such lithium storage nanostructures having an aspect ratio of 4:1 or higher. Alternatively, there is an average of fewer than 1 such lithium storage nanostructures per 1600 square micrometers. As noted below, the current collector may have a high surface roughness or include nanostructures, but these features are separate from the lithium storage layer and different than lithium storage nanostructures.

In some embodiments, deposition conditions are selected in combination with the current collector so that the lithium storage layer, e.g., a continuous porous lithium storage layer, is relatively smooth providing an anode with diffuse or total reflectance of at least 10% at 550 nm, alternatively at least 20% (measured at the continuous porous lithium storage layer side). In some embodiments, anodes having such diffuse or total reflectance may be less prone to damage from physical handling. In some embodiments, anodes that are not substantially free of lithium storage nanostructure may have lower reflectance and may be more prone to damage from physical handling.

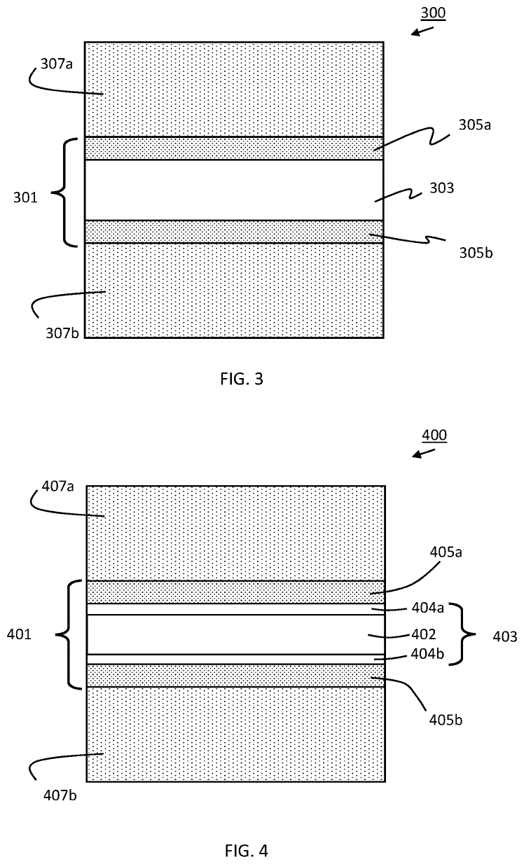

Anodes of the present disclosure may optionally be two-sided. For example, FIG. 3 is a cross-sectional view of a two-sided anode according to some embodiments. The current collector 301 may include electrically conductive layer 303 and surface layers (305a, 305b) provided on either side of the electrically conductive layer 303. Lithium storage layers (307a, 307b), which may be continuous porous lithium storage layers, are disposed on both sides to form anode 300. Surface layers 305a and 305b may be the same or different with respect to composition, thickness, roughness or some other property. Similarly, lithium storage layers 307a and 307b may be the same or different with respect to composition, thickness, porosity or some other property.

### Current Collector

In some embodiments, the current collector or the electrically conductive layer may be characterized by a tensile strength Rm or a yield strength Re. In some cases, the tensile and yield strength properties of the current collector are dependent primarily on the electrically conductive layer, which in some embodiments, may be thicker than the surface layer. If the tensile strength is too high or too low, it may be difficult to handle in manufacturing such as in roll-to-roll processes. During electrochemical cycling of the anode, deformation of the anode may occur if the tensile strength is too low, or alternatively, adhesion of the lithium storage layer may be compromised if the tensile strength is too high.

Deformation of the anode is not necessarily a problem for all products, and such deformation may sometimes only occur at higher capacities, i.e., higher loadings of lithium storage layer material. For such products, the current collector or electrically conductive layer may be characterized by a tensile strength Rₘ in a range of 100-150 MPa, alternatively 150-200 MPa, alternatively 200-250 MPa, alternatively 250-300 MPa, alternatively 300-350 MPa, alternatively 350-400 MPa, alternatively 400-500 MPa, alternatively 500-600 MPa, alternatively 600-700 MPa, alternatively 700-800 MPa, alternatively 800-900 MPa, alternatively 900-1000 MPa, alternatively 1000-1200 MPa, alternatively 1200-1500 MPa, or any combination of ranges thereof.

In some embodiments, significant anode deformation should be avoided, but low battery capacities may not be acceptable. For example, when the anode includes 7 μm or more of amorphous silicon and/or the electrochemical cycling capacity is 1.5 mAh/cm² or greater, the current collector or electrically conductive layer may be characterized by a tensile strength Rₘ of at least 500 MPa, alternatively at least 600 MPa. In such embodiments, the tensile strength may be in a range of 500-550 MPa, alternatively 550-600 MPa, alternatively 600-650 MPa, alternatively 650-700 MPa, alternatively 700-750 MPa, alternatively 750-800 MPa, alternatively 800-850 MPa, alternatively 850-900 MPa, alternatively 900-950 MPa, alternatively 950-1000 MPa, alternatively 1000-1200 MPa, alternatively 1200-1500 MPa, or any combination of ranges thereof. In some embodiments, the current collector or electrically conductive layer may have a tensile strength of greater than 1500 MPa. In some embodiments, the current collector or electrically conductive layer is in the form of a foil having a tensile strength of greater than 600 MPa and an average thickness in a range of 4-8 μm, alternatively 8-10 μm, alternatively 10-15 μm, alternatively 10-15 μm, alternatively 15-20 μm, alternatively 20-25 μm, alternatively 25-30 μm, alternatively 30-40 μm, alternatively 40-50 μm, or any combination of ranges thereof.

In some embodiments the electrically conductive layer may have a conductivity of at least 10³ S/m, or alternatively at least 10⁶ S/m, or alternatively at least 10⁷ S/m, and may include inorganic or organic conductive materials or a combination thereof. For anodes having low capacity and/or where there are no concerns regarding anode deformation during use, a wide variety of conductive materials may be used as the electrically conductive layer. In some embodiments, the electrically conductive layer includes a metallic material, e.g., titanium (and its alloys), nickel (and its alloys), copper (and its alloys), or stainless steel. In some embodiments, even metals that may normally react or alloy with lithium, e.g., tin or aluminum, may be suitable if the surface layer is sufficiently protective. In some embodiments, the electrically conductive layer may include a multilayer structure, e.g., include multiple layers of metal. In some embodiments, the electrically conductive layer may be a clad foil. In some embodiments, the electrically conductive layer includes an electrically conductive carbon, such as carbon black, carbon nanotubes, graphene, graphene oxide, reduced graphene oxide, and graphite. In some embodiments the electrically conductive layer may be in the form of a foil, a mesh, a fiber, or sheet of conductive material. Herein, a “mesh” includes any electrically conductive structure having openings such as found in interwoven wires, foam structures, foils with an array of holes, or the like. In some embodiments, the electrically conductive layer may include multiple layers of different electrically conductive materials. The electrically conductive layer may be in the form of a layer deposited onto an insulating substrate (e.g., a polymer sheet or ceramic substrate coated with a conductive material, including but not limited to, nickel or copper, optionally on both sides). In some embodiments, the electrically conductive layer includes a mesh or sheet of electrically conductive carbon, including but not limited to, those formed from bundled carbon nanotubes or nanofibers, or carbon fiber.

When higher tensile strength is desirable, the electrically conductive layer may include nickel (and certain alloys), titanium (and certain alloys), or certain copper alloys, such as brass (an alloy primarily of copper and zinc), bronze (an alloy primarily of copper and tin), CuMgAgP (an alloy primarily of copper, magnesium, silver, and phosphorous), CuFe2P (an alloy primarily of copper, iron, and phosphorous) CuNi3Si (an alloy primarily of copper, nickel, and silicon). The nomenclature for the metal alloys is not the stoichiometric molecular formula used in chemistry but rather the nomenclature used by those of ordinary skill in the alloy arts. For example, CuNi3Si does not mean there are three atoms of nickel and one atom of silicon for each atom of copper. In some embodiments these nickel- or copper-based higher tensile electrically conductive layers may include roll-formed nickel or copper alloy foils.

Alternatively, a mesh or sheet of electrically conductive carbon, including but not limited to, those formed from bundled carbon nanotubes or nanofibers, may provide higher tensile strength electrically conductive layers. In some embodiments, an electrically conductive metal interlayer may be interposed between the electrically conductive carbon and the surface layer.

In some embodiments, any of the above-mentioned electrically conductive layers (low or high tensile strength) may act as a primary electrically conductive layer and further include an electrically conductive interlayer, e.g., a metal interlayer, disposed between the primary electrically conductive layer and the surface layer. FIG. 4 is a cross-sectional view of such an anode according to some embodiments, in this case, for a two-sided anode. The current collector 401 may include electrically conductive layer 403 and surface layers (405a, 405b) provided on either side of the electrically conductive layer 403. Lithium storage layers (407a, 407b), which may be continuous porous lithium storage layers, may be disposed on both sides to form anode 400. Electrically conductive layer 403 includes a primary electrically conductive layer 402 with metal interlayers (404a, 404b) provided on either side. Metal interlayers 404a and 404b may be the same or different with respect to composition, thickness, roughness, or some other property. Similarly, surface layers 405a and 405b may be the same or different with respect to composition, thickness, roughness or some other property. Similarly, lithium storage layers 407a and 407b may be the same or different with respect to composition, thickness, porosity or some other property.

The metal interlayer may be applied by, e.g., by sputtering, vapor deposition, electrolytic plating or electroless plating, or any convenient method. The metal interlayer generally has an average thickness of less than 50% of the average thickness of the total electrically conductive layer, i.e., the combined thickness of primary electrically conductive layer and metal interlayer(s). In some embodiments, the surface layer may form more uniformly over, or adhere better to, the metal interlayer than to the primary electrically conductive layer.

In some embodiments, the current collector may be characterized as having a surface roughness. In some embodiments, the top surface 108 of the lithium storage layer 107 may have a lower surface roughness than the surface roughness of current collector 101. Herein, surface roughness comparisons and measurements may be made using the Roughness Average (Rₐ), RMS Roughness (R_{q}), Maximum Profile Peak Height roughness (Rₚ), Average Maximum Height of the Profile (R_{z}), or Peak Density (P_{c}). In some embodiments, the current collector may be characterized as having both a surface roughness R_{z}≥2.5 μm and a surface roughness Rₐ ≥0.25 μm. In some embodiments, R_{z} is in a range of 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0 to 10 μm, 10 to 12 μm, 12 to 14 μm or any combination of ranges thereof. In some embodiments, Rₐ is in a range of 0.25-0.30 μm, alternatively 0.30-0.35 μm, alternatively 0.35-0.40 μm, alternatively 0.40-0.45 μm, alternatively 0.45-0.50 μm, alternatively 0.50- 0.55 μm, alternatively 0.55-0.60 μm, alternatively 0.60-0.65 μm, alternatively 0.65-0.70 μm, alternatively 0.70-0.80 μm, alternatively 0.80-0.90 μm, alternatively 0.90-1.0 μm, alternatively 1.0-1.2 μm, alternatively 1.2-1.4 μm, or any combination of ranges thereof.

In some embodiments, some or most of the surface roughness of the current collector may be imparted by the electrically conductive layer and/or a metal interlayer. Alternatively, some or most of the surface roughness of the current collector may be imparted by the surface layer. Alternatively, some combination of the electrically conductive layer, metal interlayer, and surface layer may contribute substantially to the surface roughness.

In some embodiments, the electrically conductive layer may include roughening features, e.g., electrodeposited roughening features, to increase surface roughness. In some embodiments, the electrodeposited roughening features may include copper features. For instance, a relatively smooth copper foil may be provided into a first acid copper plating solution having 50 to 250 g/L of sulfuric acid and less than 10 g/L copper provided as copper sulfate. Copper roughening features may be deposited at room temperature by cathodic polarization of the copper foil and applying a current density of about 0.05 to 0.3 A/cm² for a few seconds to a few minutes. In some embodiment, the copper foil may next be provided into a second acid copper plating solution having 50 to 200 g/L of sulfuric acid and greater than 50 g/L copper provided as copper sulfate. The second acid copper bath may optionally be warmed to temperature of about 30° C. to 50° C. A thin copper layer may be electroplated at over the copper features to secure the particles to the copper foil by cathodic polarization and applying a current density of about 0.05 to 0.2 A/cm² for a few seconds to a few minutes.

Alternatively, or in combination with the electrodeposited roughening features, the electrically conductive layer may undergo another electrochemical, chemical or physical treatment to impart a desired surface roughness prior to formation of the surface layer.

In some embodiments, a metal foil, including but not limited to, a rolled copper foil, may be first heated in an oven in air (e.g., between 100° and 200° C.) for a period of time (e.g., from 10 minutes to 24 hours) remove any volatile materials on its surface and cause some surface oxidation. In some embodiments, the heat-treated foil may then be subjected to additional chemical treatments, e.g., immersion in a chemical etching agent such as an acid or a hydrogen peroxide/HCl solution optionally followed by deionized water rinse. The chemical etching agent removes oxidized metal. Such treatment may increase the surface roughness. In some embodiments, there is no heating, but a treatment with a chemical etching agent that includes an oxidant. In some embodiments, the oxidant may be dissolved oxygen, hydrogen peroxide, or some other appropriate oxidant. Such chemical etching agents may further include an organic acid such as methanesulfonic acid or an inorganic acid such as hydrochloric or sulfuric acid. A chemical etching agent may optionally be followed by deionized water rinse. Such treatments described in this paragraph may be referred to herein as “chemical roughening” treatments.

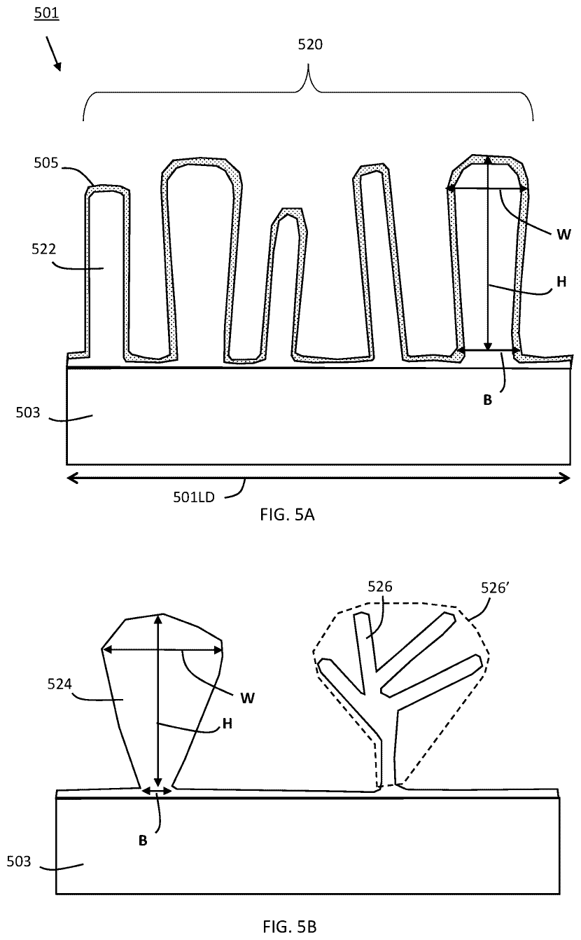

In some embodiments, the electrodeposited roughening features may be characterized as nanopillar features. FIG. 5A illustrates a cross-sectional view of a non-limiting example of electrodeposited copper roughening features according to some embodiments. In some cases, current collector 501 may include a plurality of nanopillar features 520 (electrodeposited copper roughening features) disposed over the electrically conductive layer 503. Nanopillar features 520 are distinguished from nanopillars 192 of FIG. 2 at least by their compositions, their layers, their dimensions, the processes used to form the nanopillars, their surface densities, and/or their orientations. Nanopillar features 520 may include a metal-containing nanopillar core 522 (e.g., copper-containing core) and a surface layer 505 provided at least partially over the nanopillar core and optionally over the electrically conductive layer in interstitial areas between nanopillar features. The nanopillar features may each be characterized by a height H, a base width B, and a maximum width W. The base width B may be the minimum width across the bottom or base of the nanopillar feature. The maximum width W may be measured across the widest section orthogonal to the nanopillar feature axis. The height H may be measured from the base to the end of the nanopillar feature along the nanopillar feature axis. The nanopillar axis is the longitudinal axis of the nanopillar feature. In some cases, the nanopillar feature axis may pass through the center of mass of the nanopillar feature

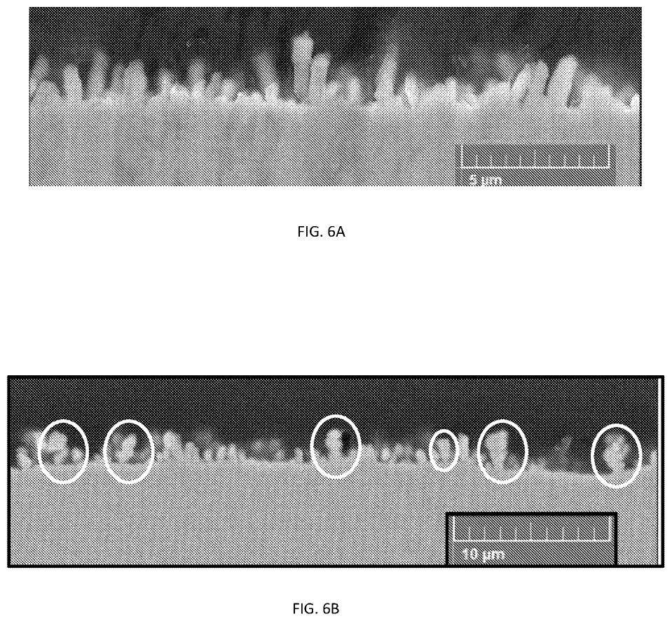

In some embodiments, nanopillar features may be characterized as first-type and second-type nanopillars. In some cases, first-type nanopillars may be characterized by: H in a range of 0.4 μm to 3.0 μm; B in a range of 0.2 μm to 1.0 μm; a W/B ratio in a range of 1 to 1.5; an H/B (aspect) ratio in a range of 0.8 to 4.0; and an angle of the longitudinal axis of the nanopillar feature to the plane of the electrically conductive layer in a range of 60° to 90°. For example, most or all of the nanopillar features in FIG. 5A may be first-type nanopillars. FIG. 6A is an SEM cross-section of a non-limiting example of a current collector having mostly first-type nanopillar features. In some embodiments, in an optical or SEM analysis, a single or an average 20 μm long cross section of the current collector may include at least two (2) first-type nanopillars, alternatively at least 3, at least 4, at least 5, at least 6, at least 7, at least 8, or at least 10 first-type nanopillars. In some embodiments, in an optical or SEM analysis, a single or an average 20 μm long cross section of the current collector may include 2-4 first-type nanopillars, alternatively 4-6, alternatively 6-8, alternatively 8-10, alternatively 10-12, alternatively 12-14, alternatively 14-16, alternatively 16-20, alternatively 20-25, alternatively 25-30, or any combination of ranges thereof. Note that the 20 μm length of analysis refers to a lateral distance 501LD along the length of the current collector, for example, as indicated in FIG. 5A.

In some cases, second-type nanopillars may be characterized by H of at least 1.0 μm and a W/B ratio greater than 1.5. That is, second-type nanopillars tend to widen away from their base. FIG. 5B is a cross-sectional view of a non-limiting example of second-type nanopillars. For clarity the nanopillar core and surface layers are not separately defined. A second-type nanopillar may have a significantly wider upper portion (sometimes referred to herein as “wide-top roughening features”) such as nanopillar feature 524. Alternatively, a second-type nanopillar may include a branched or tree-like structure as in nanopillar feature 526. Although the “trunk” and “branches” are all similar in width, the feature overall is significantly wider toward the top as illustrated by effective cross section profile 526′. Effective cross section profile 526′ is a shape formed by lines drawn between the outermost points of consecutive branches or trunk of the nanopillar feature. Such branched structures may have the same effect as a solid nanopillar feature like 524.

FIG. 6B is an SEM cross-section of a non-limiting example of a current collector having some second-type nanopillars (circled). The performance of anodes having second-type nanopillars may be acceptable in many embodiments. However, in some embodiments, it has been observed that anodes having a large number of second-type nanopillars may occasionally be inferior relative to anodes having fewer second-type nanopillars. Not being bound by theory, it may be that the wide tops interfere with the roughening features from becoming embedded in the silicon. Alternatively, these structures may be structurally fragile and may break at the base. Regardless, current collectors having too many of such structures may in some embodiments not perform well with PECVD-deposited lithium storage materials. In some embodiments, in an optical or SEM analysis, at least one 20 μm long cross section of the current collector may include fewer second-type nanopillars than first-type nanopillars. In some embodiments, in an optical or SEM analysis, an average 20 μm long cross section of the current collector (e.g., taken from three measurements) may include fewer second-type nanopillars than first-type nanopillars. In some embodiments, in an optical or SEM analysis, at least one 20 μm long cross section of the current collector may include fewer than ten (10), alternatively fewer than 9, fewer than 8, fewer than 7, fewer than 6, fewer than 6, fewer than 4, fewer than 3, fewer than 2, or fewer than 1 second-type nanopillar(s). In some embodiments, in an optical or SEM analysis, an average 20 μm long cross section of the current collector (e.g., taken from three measurements) may include fewer than ten (10), alternatively fewer than 9, fewer than 8, fewer than 7, fewer than 6, fewer than 6, fewer than 4, fewer than 3, fewer than 2, or fewer than 1 second-type nanopillar(s).

In some embodiments, the nanopillars may fall into a category other than first-type nanopillars or second-type nanopillars. In some embodiments, the electrodeposited roughening features may be characterized as nodular features, which may in some cases include particulate or hemispheroidal features. In some embodiments, the base of the nodular feature may generally represent the maximum width. In some embodiments, a nodular feature may be characterized as having H in a range of 0.4 to 5.0 μm, a W/B ratio in a range of about 1 to 1.2, and H/B aspect ratio in a range of about 0.5 to 1.5. In some cases, an electrodeposited roughening feature may be defined as either nodular or a first-type nanopillar.

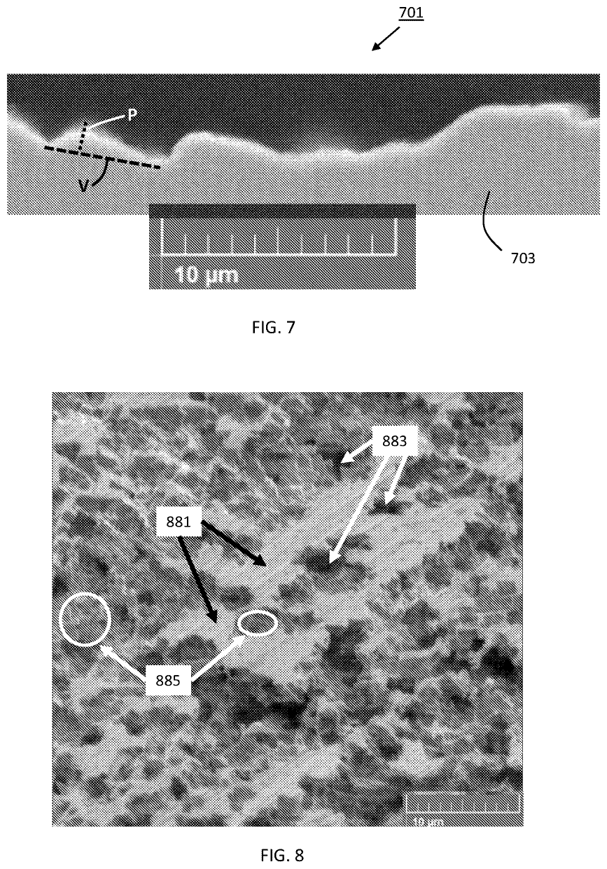

In some embodiments, the surface roughness may be relatively large with respect to Rₐ or R_{z}, but the features themselves may be broad roughness features, e.g., as bumps and hills separated on average by at least about 2 μm microns. FIG. 7 is an SEM cross-sectional view of a portion of a current collector having broad roughness features. Current collector 701 includes electrically conductive layer 703 (the surface layer is not easy to make out in the SEM). This current collector had a measured surface roughness Rₐ=508 nm. The broad roughness features may be characterized by a peak height P and a valley-to-valley separation V. The ratio P/V represents an aspect ratio of the broad roughness feature. In some embodiments, on average, V is greater than at least 3 μm or alternatively at least 4 μm, and P/V is less than 0.8, alternatively less than 0.6. In some embodiments, on average, V is in a range of 3-4 μm, alternatively 4-5 μm, alternatively 5-6 μm, alternatively 6-8 μm, alternatively, 8-10 μm, alternatively 10-12 μm, alternatively 12-15 μm, and P/V is in a range of 0.2-0.3, alternatively 0.3-0.4, alternatively 0.4-0.5, alternatively 0.5-0.6, alternatively 0.6-0.7, alternatively 0.7-0.8, or any combination of ranges thereof for V and P/V. In some embodiments, V is the same as the peak-to-peak separation.

In some embodiments, a roughened current collector surfaces may appear pitted, cratered, or corroded. A non-limiting example is shown in FIG. 8, in this case made by a chemical roughening, oxidative treatment. Some areas corresponding approximately to the original surface can still be seen such as in areas 881—one can still make out lines from the original roll-formed surface. The majority of the surface has been etched leading to very rough, random, cratered topology that is much rougher than the original surface. In some embodiments, at least 50% of the surface of the electrically conductive layer has been etched to a depth of at least 0.5 μm from the original surface, alternatively at least 1.0 μm, wherein the surface roughness Rₐ is at least 400 nm, alternatively at least 500 nm, alternatively at least 600 nm, alternatively at least 700 nm. Numerous pits/craters 883 are visible. In some embodiments when inspected by SEM analysis, an average 100 square micron area of a chemically roughened current collector may include at least 1 recognizable pit, alternatively at least 2, 3, or 4. In some embodiments, a “pit” may be a feature characterized by a width and a depth, where the depth to width ratio is at least 0.25, alternatively at least 0.5. The pit may be a concavity defined by the current collector. The top of the pit may be the top surface of the current collector. In some embodiments, a pit may be at least 2 μm wide. In some embodiments, pits may occupy 2% to 5% of the surface area of the current collector, alternatively 5% to 10%, alternatively, 10% to 20%, alternatively 20% to 30%, alternatively 30% to 40%, alternatively 40% to 50%. In some embodiments, some etched areas or pitted areas may have a fine roughness structure 885 formed from the coalescence of secondary smaller pits or craters. Such secondary pits may have an average width or diameter of less than about 2 μm, alternatively less than about 1 μm. In some embodiments, secondary pits may occupy 5% to 10% of the surface area of the current collector, alternatively 5% to 10%, alternatively, 10% to 20%, alternatively 20% to 30%, alternatively 30% to 40%, alternatively 40% to 50%, alternatively 50% to 60%, alternatively, 60% to 70%, alternatively 70% to 90%.

In some embodiments, roughening of the electrically conductive layer may include, for example, physical abrasion (such as sandpaper, sand blasting, polishing, or the like), ablation (such as by laser ablation), embossing, stamping, casting, imprinting, chemical treatments, electrochemical treatments, or thermal treatments. In some cases, such roughening may be used to form one or more of the roughening features described above, e.g., nodular features, nanopillar features, broad roughness features, pitted features, or the like. In some cases, roughening features may be random, or alternatively, may have a predetermined pattern.

### Surface Layer

Although chromate has been found in some cases to be an effective surface layer, e.g., as disclosed in co-pending international application PCT/US2021/039426 filed Jun. 28, 2021 (which is incorporated by reference herein for all purposes), such chromate coatings often require the use of Cr(VI) materials which are subject to environmental regulations and restrictions in many areas. Further, chromate surface layers have been found in some cases to be more effective in combination with an underlying zinc or zinc alloy surface layer. This additional layer or layers are referred to as “sublayers” in PCT/US2021/039426. In some cases, it would be desirable to simplify the surface layer preparation and use less toxic materials.

In some embodiments, the surface layer may include, or be formed from, a transition metallate other than chromate. The surface layer may be provided in direct contact with the electrically conductive layer without the need for an intervening zinc-containing layer. In some embodiments, the surface layer may be formed by electroplating. In some cases, the surface layer may be formed by a so-called “conversion coating” process where typically some elements of the electrically conductive layer react with a conversion coating mixture, e.g., an aqueous or non-aqueous solution that includes a transition metallate compound, to cause direct deposition of the transition metallate or a reaction product thereof. As a non-limiting example, when the electrically conductive layer includes copper, copper (0) may reduce a transition metallate or transition metallate precursor compound in solution to a lower oxidation state which may have lower solubility and cause precipitation directly onto the electrically conductive layer. The copper ion formed may dissolve into solution, or alternatively may be a counterion to the coated transition metallate. Conversion coating processes are known in the art for other (non-battery anode) purposes and alternative reaction mechanisms are possible, many of which do not require copper.

In some embodiments, a surface layer may be formed by adsorption of a transition metallate compound to the surface of the electrically conductive layer. In some embodiments, a surface layer may be formed by coating and drying a transition metallate compound over the electrically conductive layer.

In some embodiments, one or more additional layers may be provided over the transition metallate surface layer wherein the plurality of layers (which may be referred to as sublayers) collectively make up the surface layer. However, to further simplify manufacturing, the lithium storage layer may be deposited directly onto (in contact with) the surface layer having the non-chromate transition metallate.

A transition metallate generally refers to a transition metal compound bearing a negative charge. The anionic transition metal compound may be associated with one or more cations (a “transition metallate compound”), which may optionally be an alkali metal, an alkaline earth metal, ammonium, alkylammonium, another transition metal (which may be the same or different than the transition metal of the anionic transition metal compound), or some other cationic species. Some non-limiting examples of transition metallates include oxometallates, sulfometallates, cyanometallates, and halometallates, which may be used singly or in combination. Unless otherwise noted, the term “transition metal” as used anywhere in the present application includes any element in groups 3 through 12 of the periodic table, including lanthanides and actinides.

In some embodiments, the surface layer (the transition metallate) may include scandium, titanium, vanadium, manganese, iron, cobalt, nickel, copper, yttrium, zirconium, niobium, molybdenum, tantalum, or tungsten. In some embodiments, the transition metallate includes an oxometallate. In some cases, the oxometallate includes a titanate, a vanadate, a molybdate, a tungstate, or a niobate. In some embodiments, a surface layer may further include some chromium, e.g., in the form of chromate. In some cases, the chromate may present as a sublayer, e.g., where the non-chromate transition metallate sublayer is provided between the chromate sublayer and the lithium storage layer. In some embodiments, chromium present in a surface layer may be in a lower atomic percent than the transition metal present in the non-chromate transition metallate.

In some embodiments, the amount of transition metal element(s) in the surface layer may be at least 0.5 mg/m², alternatively at least 1 mg/m², alternatively at least 2 mg/m². In some embodiments, the amount of transition metal element(s) in the surface layer may be in a range of 0.5-1 mg/cm², alternatively 1-2 mg/m², alternatively 2-5 mg/m², alternatively 5 -10 mg/m², alternatively 10-20 mg/m², alternatively 20-50 mg/m², alternatively 50-75 mg/m², alternatively 75-100 mg/m², alternatively 100-250 mg/m², alternatively 250-500 mg/m², alternatively 500-750 mg/m², alternatively 750-1000 mg/m² or any combination of ranges thereof. In some embodiments, the surface layer containing the transition metallate may be at least 0.2 nm thick, alternatively at least 0.5 nm thick, alternatively at least 1 nm thick, at least 2 nm thick. In some embodiments a surface layer containing the transition metallate may have a thickness in a range of 0.2-0.5 nm, alternatively 0.5-1.0 nm, alternatively 1.0-2.0 nm, alternatively 2.0-5.0 nm, alternatively 5.0-10 nm, alternatively 10-20 nm, alternatively 20-50 nm, alternatively 50-100 nm, alternative 100-200 nm, alternatively 200-500 nm, alternatively 500-750 nm, alternatively 750-1000 nm, or any combination of ranges thereof.

In some embodiments, the surface layer may be characterized is a single layer not having any defined sublayers. In some cases, the surface layer may have a homogeneous composition throughout. In some embodiments, the surface layer may have a heterogeneous composition. In some embodiments, the composition of the surface layer may include a gradient with respect to the concentration of one or more chemical components. For example, the chemical reactions involved in a single conversion coating treatment may change over time as the surface composition changes, which may result in a gradation of components. In some cases, a gradient may be caused by surface oxidation or other reactions. In embodiments where the surface layer includes a gradient, the surface layer may be characterized by having the same chemical components throughout, with some chemical components possibly going to zero concentration in some locations at the end of a gradient. The surface layer may in some cases not include abrupt changes in the concentration of chemical components.

In addition to being useful for vapor deposited lithium storage layers, the current collectors described herein may also be suitable for more conventional slurry-coated anodes such as those containing graphite, silicon particles, or other anode-active materials. In some cases, the current collectors described herein may be suitable for use with lithium metal anodes. For example, instead of a lithium storage layer, a layer of lithium metal is provided over the surface layer as the active anode material. Lithium can be deposited electrochemically, by thermal evaporation, by slurry-coating, or the like. In some embodiments, current collectors of the present application may be suitable for use as cathode current collectors.

### Silicon Compounds

In some embodiments, a surface layer that includes the transition metallate may be formed from a coating solution (e.g., electroplating, conversion coating, adsorption, or the like) that includes a silicon compound such as a silane, a siloxane, or a silazane compound, any of which may be referred to herein as a silicon compound agent, which co-deposits with the transition metallate. Some examples of silicon compounds are disclosed in international application PCT/US2021/039426. Although a transition metallate may be effective in combination with such silicon compounds, in some embodiments, a non-chromate transition metallate may be used as a surface layer without mixing or combining it with such silicon compounds. In some cases, this may further simplify the manufacturing process by reducing the number of materials to monitor in an electrolytic plating or conversion coating bath. That is, in some embodiments, the surface layer may be substantially free of such silicon compounds. By substantially free, the atomic ratio of the transition metal(s) in the surface layer to silicon from the silicon compound may be at least 5:1, alternatively at least 10:1, alternatively at least 20:1, alternatively at least 50:1, or alternatively at least 100:1. Note that, in some embodiments, a silicon compound may be provided over the transition metallate in a separate step, for example, by contact with a silicon compound agent.

### Lithium Storage Layer

In some embodiments, the lithium storage layer may be a porous material capable of reversibly incorporating lithium, e.g., a continuous porous lithium storage layer. In some embodiments, the lithium storage layer includes silicon, germanium, antimony, tin, or a mixture of two or more of these elements. In some embodiments, the lithium storage layer is substantially amorphous. In some embodiments, the lithium storage layer includes substantially amorphous silicon. Such substantially amorphous storage layers may include a small amount (e.g., less than 20 atomic %) of crystalline material dispersed therein. The storage layer may include dopants such as hydrogen, boron, phosphorous, carbon, sulfur, fluorine, aluminum, gallium, indium, arsenic, antimony, bismuth, nitrogen, or metallic elements. In some embodiments the lithium storage layer may include porous substantially amorphous hydrogenated silicon (a-Si:H), having, e.g., a hydrogen content of from 0.1 to 20 atomic %, or alternatively higher. In some embodiments, the lithium storage layer may include methylated amorphous silicon. Note that, unless referring specifically to hydrogen content, any atomic % metric used herein for a lithium storage material or layer refers to atoms other than hydrogen.

In some embodiments, the lithium storage layer, e.g., a continuous porous lithium storage layer, includes at least 40 atomic % silicon, germanium or a combination thereof, alternatively at least 50 atomic %, alternatively at least 60 atomic %, alternatively at least 70 atomic %, alternatively, at least 80 atomic %, alternatively at least 90 atomic %, alternatively at least 95%, alternatively at least 97%, alternatively at least 98%, or alternatively at least 99%. In some embodiments, the lithium storage layer, e.g., a continuous porous lithium storage layer, includes at least 40 atomic % silicon, alternatively at least 50 atomic %, alternatively at least 60 atomic %, alternatively at least 70 atomic %, alternatively, at least 80 atomic %, alternatively at least 90 atomic %, alternatively at least 95 atomic %, alternatively at least 97 atomic %, alternatively at least 98%, or alternatively at least 99%. Note that in the case of prelithiated anodes as discussed below, the lithium content is excluded from this atomic % characterization.

In some embodiments, the lithium storage layer, e.g., a continuous porous lithium storage layer includes less than 10 atomic % carbon, alternatively less than 5 atomic %, alternatively less than 2 atomic %, alternatively less than 1 atomic %, alternatively less than 0.5 atomic %, alternatively less than 0.3%. In some embodiments, lithium storage layer, e.g., a continuous porous lithium storage layer is substantially free (i.e., the lithium storage layer includes less than 1% by weight, alternatively less than 0.5% by weight, alternatively less than 0.3% by weight, alternatively less than 0.1% by weight, alternatively less than 0.01% by weight) of carbon-based binders, graphitic carbon, graphene, graphene oxide, reduced graphene oxide, carbon black and conductive carbon. A few non-limiting examples of carbon-based binders may include organic polymers such as those based on styrene butadiene rubber, polyvinylidene fluoride, polytetrafluoroethylene, polyacrylic acid, carboxymethyl cellulose, or polyacrylonitrile.

The lithium storage layer, e.g., a continuous porous lithium storage layer, may include voids or interstices (pores), which may be random or non-uniform with respect to size, shape, and distribution. Such porosity does not result in, or a result from, the formation of any recognizable lithium storage nanostructures such as nanowires, nanopillars, nanotubes, ordered nanochannels or the like. In some embodiments, the pores may be polydisperse. In some embodiments, the continuous porous lithium storage layer may be characterized as nanoporous. In some embodiments the continuous porous lithium storage layer has an average density in a range of 1.0-1.1 g/cm³, alternatively 1.1-1.2 g/cm³, alternatively 1.2-1.3 g/cm³, alternatively 1.3-1.4 g/cm³, alternatively 1.4-1.5 g/cm³, alternatively 1.5-1.6 g/cm³, alternatively 1.6-1.7 g/cm³, alternatively 1.7-1.8 g/cm³, alternatively 1.8-1.9 g/cm³, alternatively 1.9-2.0 g/cm³, alternatively 2.0-2.1 g/cm³, alternatively 2.1-2.2 g/cm³, alternatively 2.2-2.25 g/cm³, alternatively 2.25-2.29 g/cm³, or any combination of ranges thereof, and includes at least 70 atomic % silicon, 80 atomic % silicon, alternatively at least 85 atomic % silicon, alternatively at least 90 atomic % silicon, alternatively at least 95 atomic % silicon, alternatively at least 97 atomic % silicon, alternatively at least 98 atomic % silicon, alternatively at least 99 atomic % silicon. Note that a density of less than 2.3 g/cm³ is evidence of the porous nature of a-Si containing lithium storage layers.

In some embodiments, the majority of active material (e.g., silicon, germanium or alloys thereof) of the lithium storage layer, e.g., a continuous porous lithium storage layer, has substantial lateral connectivity across portions of the current collector creating, such connectivity extending around random pores and interstices. Referring again to FIG. 1, in some embodiments, “substantial lateral connectivity” means that active material at one point X in the continuous porous lithium storage layer 107 may be connected to active material at a second point X′ in the layer at a straight-line lateral distance LD that is at least as great as the average thickness T of the lithium storage layer, alternatively, a lateral distance at least 2 times as great as the thickness, alternatively, a lateral distance at least 3 times as great as the thickness. Not shown, the total path distance of material connectivity, including circumventing pores and following the topography of the current collector, may be longer than LD. In some embodiments, the continuous porous lithium storage layer may be described as a matrix of interconnected silicon, germanium or alloys thereof, with random pores and interstices embedded therein. In some embodiments, the lithium storage layer, e.g., a continuous porous lithium storage layer, may in a cross-sectional view have a sponge-like form. It should be noted that the lithium storage layer, e.g., a continuous porous lithium storage layer, does not necessarily extend across the entire anode without any lateral breaks and may include random discontinuities or cracks and still be considered continuous. In some embodiments, such discontinuities may occur more frequently on rough current collector surfaces. In some embodiments, the lithium storage layer, e.g., a continuous porous lithium storage layer, may in a cross-sectional view have abutting columns of active material such as silicon. The abutting columns may be characterized by an average height and average width, and generally have a height-to-width aspect ratio of less than 4:1, alternatively less than 3:1, alternatively less than 2:1, alternatively less than 1:1. Such abutting columns are laterally continuous. In some embodiments, the lithium storage layer, e.g., a continuous porous lithium storage layer, may include a matrix of connected nanoparticle aggregates. In some embodiments, the lithium storage layer may include a mixture of amorphous and crystalline silicon, e.g., nano-crystalline silicon having an average grain size of less than about 100 nm, alternatively less than about 50 nm, 20 nm, 10 nm, or 5 nm. In some cases, the lithium storage layer may include up to 30 atomic % nano-crystalline silicon relative to all silicon in the lithium storage layer.

In some embodiments, the lithium storage layer, e.g., a continuous porous lithium storage layer, includes a substoichiometric oxide of silicon (SiOₓ), germanium (GeOₓ) or tin (SnOₓ) wherein the ratio of oxygen atoms to silicon, germanium or tin atoms is less than 2:1, i.e., x<2, alternatively less than 1:1, i.e., x<1. In some embodiments, x is in a range of 0.02 to 0.95, alternatively 0.02 to 0.10, alternatively 0.10 to 0.50, or alternatively 0.50 to 0.95, alternatively 0.95 to 1.25, alternatively 1.25 to 1.50, or any combination of ranges thereof.

In some embodiments, the lithium storage layer, e.g., a continuous porous lithium storage layer, includes a substoichiometric nitride of silicon (SiN_{y}), germanium (GeN_{y}) or tin (SnN_{y}) wherein the ratio of nitrogen atoms to silicon, germanium or tin atoms is less than 1.25:1, i.e., y<1.25. In some embodiments, y is in a range of 0.02 to 0.95, alternatively 0.02 to 0.10, alternatively 0.10 to 0.50, or alternatively 0.50 to 0.95, alternatively 0.95 to 1.20, or any combination of ranges thereof. Lithium storage layer having a substoichiometric nitride of silicon may also be referred to as nitrogen-doped silicon or a silicon-nitrogen alloy.

In some embodiments, the lithium storage layer, e.g., a continuous porous lithium storage layer, includes a substoichiometric oxynitride of silicon (SiOₓN_{y}), germanium (GeOₓN_{y}), or tin (SnOₓN_{y}) wherein the ratio of total oxygen and nitrogen atoms to silicon, germanium or tin atoms is less than 1:1, i.e., (x+y)<1. In some embodiments, (x+y) is in a range of 0.02 to 0.95, alternatively 0.02 to 0.10, alternatively 0.10 to 0.50, or alternatively 0.50 to 0.95, or any combination of ranges thereof.

In some embodiments, the above sub-stoichiometric oxides, nitrides or oxynitrides are provided by a CVD process, including but not limited to, a PECVD process. The oxygen and nitrogen may be provided uniformly within the continuous porous lithium storage layer, or alternatively the oxygen or nitrogen content may be varied as a function of storage layer thickness.

### CVD

CVD generally involves flowing a precursor gas, a gasified liquid in terms of direct liquid injection CVD or gases and liquids into a chamber containing one or more objects, typically heated, to be coated. Chemical reactions may occur on and near the hot surfaces, resulting in the deposition of a thin film on the surface. This is accompanied by the production of chemical by-products that are exhausted out of the chamber along with unreacted precursor gases. As would be expected with the large variety of materials deposited and the wide range of applications, there are many variants of CVD that may be used to form the lithium storage layer, the surface layer or sublayer, a supplemental layer (see below) or other layers. It may be done in hot-wall reactors or cold-wall reactors, at sub-torr total pressures to above-atmospheric pressures, with and without carrier gases, and at temperatures typically ranging from 100-1600° C. in some embodiments. There are also a variety of enhanced CVD processes, which involve the use of plasmas, ions, photons, lasers, hot filaments, or combustion reactions to increase deposition rates and/or lower deposition temperatures. Various process conditions may be used to control the deposition, including but not limited to, temperature, precursor material, gas flow rate, pressure, substrate voltage bias (if applicable), and plasma energy (if applicable).

As mentioned, a lithium storage layer such as a continuous porous lithium storage layer, e.g., a layer of silicon or germanium or both, may be provided by plasma-enhanced chemical vapor deposition (PECVD). Relative to conventional CVD, deposition by PECVD can often be done at lower temperatures and higher rates, which can be advantageous for higher manufacturing throughput. In some embodiments, the PECVD is used to deposit a substantially amorphous silicon layer (optionally doped) over the surface layer. In some embodiments, PECVD is used to deposit a substantially amorphous continuous porous silicon layer over the surface layer.

In PECVD processes, according to various implementations, a plasma may be generated in a chamber in which the substrate is disposed or upstream of the chamber and fed into the chamber. Various types of plasmas may be used including, but not limited to, capacitively-coupled plasmas, inductively-coupled plasmas, and conductive coupled plasmas. Any appropriate plasma source may be used, including DC, AC, RF, VHF, combinatorial PECVD and microwave sources may be used. In some embodiments, magnetron assisted RF PECVD may be used.

PECVD process conditions (temperatures, pressures, precursor gases, carrier gasses, dopant gases, flow rates, energies, and the like) can vary according to the particular process and tool used, as is well known in the art.

In some implementations, the PECVD process is an expanding thermal plasma chemical vapor deposition (ETP-PECVD) process. In such a process, a plasma generating gas is passed through a direct current arc plasma generator to form a plasma, with a web or other substrate including the current collector optionally in an adjoining vacuum chamber. A silicon source gas is injected into the plasma, with radicals generated. The plasma is expanded via a diverging nozzle and injected into the vacuum chamber and toward the substrate. An example of a plasma generating gas is argon (Ar). In some embodiments, the ionized argon species in the plasma collide with silicon source molecules to form radical species of the silicon source, resulting in deposition onto the current collector. Example ranges for voltages and currents for the DC plasma source are 60 to 80 volts and 40 to 70 amperes, respectively.

Any appropriate silicon source may be used to deposit silicon. In some embodiments, the silicon source may be a silane-based precursor gas including, but not limited to, silane (SiH₄), dichlorosilane (H₂SiCl₂), monochlorosilane (H₃SiCl), trichlorosilane (HSiCl₃), silicon tetrachloride (SiCl₄), disilane, tetrafluorosilane, triethylsilane, and diethylsilane. Depending on the gas(es) used, the silicon layer may be formed by decomposition or reaction with another compound, such as by hydrogen reduction. In some embodiments, the gases may include a silicon source such as silane, a noble gas such as helium, argon, neon, or xenon, optionally one or more dopant gases, and substantially no hydrogen. In some embodiments, the gases may include argon, silane, and hydrogen, and optionally some dopant gases. In some embodiments the gas flow ratio of argon relative to the combined gas flows for silane and hydrogen is at least 3.0, alternatively at least 4.0. In some embodiments, the gas flow ratio of argon relative to the combined gas flows for silane and hydrogen is in a range of 3-5, alternatively 5-10, alternatively 10-15, alternatively 15-20, or any combination of ranges thereof. In some embodiments, the gas flow ratio of hydrogen gas to silane is in a range of 0-0.1, alternatively 0.1-0.2, alternatively 0.2-0.5, alternatively 0.5-1, alternatively 1-2, alternatively 2-5, or any combination of ranges thereof. In some embodiments, higher porosity silicon may be formed and/or the rate of silicon deposition may be increased when the gas flow ratio of silane relative to the combined gas flows of silane and hydrogen increases. In some embodiments a dopant gas is borane or phosphine, which may be optionally mixed with a carrier gas. In some embodiments, the gas flow ratio of dopant gas (e.g., borane or phosphine) to silicon source gas (e.g., silane) is in a range of 0.0001-0.0002, alternatively 0.0002-0.0005, alternatively 0.0005-0.001, alternatively 0.001-0.002, alternatively 0.002-0.005, alternatively 0.005-0.01, alternatively 0.01-0.02, alternatively 0.02-0.05, alternatively 0.05-0.10, or any combination of ranges thereof. Such gas flow ratios described above may refer to the relative gas flow, e.g., in standard cubic centimeters per minute (SCCM). In some embodiments, the PECVD deposition conditions and gases may be changed over the course of the deposition.

In some embodiments, the temperature at the current collector during at least a portion of the time of PECVD deposition is in a range of 20° C. to 50° C., 50° C. to 100° C., alternatively 100° C. to 200° C., alternatively 200° C. to 300° C., alternatively 300° C. to 400° C., alternatively 400° C. to 500° C., alternatively 500° C. to 600° C., or any combination of ranges thereof. In some embodiments, the temperature may vary during the time of PECVD deposition. For example, the temperature during early times of the PECVD may be higher than at later times. Alternatively, the temperature during later times of the PECVD may be higher than at earlier times.

The thickness or mass per unit area of the lithium storage layer, e.g., a continuous porous lithium storage layer, depends on the storage material, desired charge capacity and other operational and lifetime considerations. Increasing the thickness typically provides more capacity. If the lithium storage layer becomes too thick, electrical resistance may increase and the stability may decrease. In some embodiments, the anode may be characterized as having an active silicon areal density of at least 0.2 mg/cm², alternatively at least 0.5 mg/cm², alternatively at least 1.0 mg/cm², alternatively at least 1.5 mg/cm², alternatively at least 3 mg/cm², alternatively at least 5 mg/cm². In some embodiments, the lithium storage structure may be characterized as having an active silicon areal density in a range of 0.2-0.5 mg/cm², alternatively in a range of 0.5-1.0 mg/cm², alternatively in a range of 1.0-1.5 mg/cm², alternatively in a range of 1.5-2 mg/cm², alternatively in a range of 2-3 mg/cm², alternatively in a range of 3-5 mg/cm², alternatively in a range of 5-10 mg/cm², alternatively in a range of 10-15 mg/cm², alternatively in a range of 15-20 mg/cm², or any combination of ranges thereof. “Active silicon” refers to the silicon in electrical communication with the current collector that is available for reversible lithium storage at the beginning of cell cycling, e.g., after anode “electrochemical formation” discussed later. “Areal density” refers to the surface area of the electrically conductive layer over which active silicon is provided. In some embodiments, not all of the silicon content is active silicon, i.e., some may be tied up in the form of non-active silicides or may be electrically isolated from the current collector.

In some embodiments the lithium storage layer, e.g., a continuous porous lithium storage layer, has an average thickness of at least 0.5 μm, alternatively at least 1 μm, alternatively at least 2.5 μm, alternatively at least 5 μm, alternatively at least 6.5 μm. In some embodiments, the lithium storage layer, e.g., a continuous porous lithium storage layer, has an average thickness in a range of about 0.5 μm to about 50 μm. In some embodiments, the lithium storage layer, e.g., a continuous porous lithium storage layer, comprises at least 80 atomic % amorphous silicon and/or has a thickness in a range of 1-1.5 μm, alternatively 1.5- 2.0 μm, alternatively 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0-10 μm, alternatively 10-15 μm, alternatively 15-20 μm, alternatively 20-25 μm, alternatively 25- 30 μm, alternatively 30-40 μm, alternatively 40-50 μm, or any combination of ranges thereof.

In some embodiments, rather than depositing the lithium storage material by CVD or PECVD, it may be formed by a physical vapor deposition (PVD) process such as by sputtering. Although the deposition rates of sputtering are typically lower than PECVD, sputtering may be suitable for some applications, e.g., those that require relatively lower loadings of the active material such as silicon. For example, in some embodiments, a lithium storage layer, e.g., a continuous porous lithium storage layer, formed by a sputtering process may have a thickness of less than about 15 μm, alternatively less than about 10 μm, alternatively less than 7 μm, alternatively less than 5 μm, alternatively less than 5 μm.

### Other Anode Features

The anode may optionally include various additional layers and features. The current collector may include one or more features to ensure that a reliable electrical connection can be made in the energy storage device. In some embodiments, a supplemental layer is provided over the lithium storage structure. In some embodiments, the supplemental layer is a protection layer to enhance lifetime or physical durability. The supplemental layer may be an oxide formed from the lithium storage material itself, e.g., silicon dioxide in the case of silicon, or some other suitable material. A supplemental layer may be deposited, for example, by ALD, S-ALD, CVD, i-CVD, PECVD, MLD, evaporation, sputtering, solution coating, ink jet or any method that is compatible with the anode. In some embodiments, the top surface of the supplemental layer may correspond to a top surface of the anode.

A supplemental layer should be reasonably conductive to lithium ions and permit lithium ions to move into and out of the patterned lithium storage structure during charging and discharging. In some embodiments, the lithium ion conductivity of a supplemental layer is at least 10⁻⁹ S/cm, alternatively at least 10⁻⁸ S/cm, alternatively at least 10⁻⁷ S/cm, alternatively at least 10⁻⁶ S/cm. In some embodiments, the supplemental layer acts as a solid-state electrolyte.

Some non-limiting examples of materials used in a supplemental layer include metal oxides, nitrides, or oxynitrides, e.g., those containing aluminum, titanium, vanadium, zirconium, hafnium, or tin, or mixtures thereof. The metal oxide, metal nitride or metal oxynitride may include other components such as phosphorous or silicon. The supplemental layer may include a lithium-containing material such as lithium phosphorous oxynitride (LIPON), lithium phosphate, lithium aluminum oxide, (Li,La)ₓTi_{y}O_{z}, or LiₓSi_{y}Al₂O₃. In some embodiments, the supplemental layer includes a metal oxide, metal nitride, or metal oxynitride, and has an average thickness of less than about 100 nm, for example, in a range of about 0.1 to about 10 nm, or alternatively in a range of about 0.2 nm to about 5 nm. LIPON or other solid-state electrolyte materials having superior lithium transport properties may have a thickness of more than 100 nm, but may alternatively, be in a range of about 1 to about 50 nm. In some embodiments, LIPON or other solid-state electrolyte may have a thickness in the range of 0.1-0.5 μm, alternatively 0.5-1.0 μm, alternatively 1-1.5 μm, alternatively 1.5-2.0 μm, alternatively 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0-10 μm, alternatively 10-15 μm, alternatively 15-20 μm, alternatively 20-25 μm, alternatively 25- 30 μm, alternatively 30-40 μm, alternatively 40-50 μm, or any combination of ranges thereof.

In some embodiments, the lithium storage layer, e.g., a continuous porous lithium storage layer, may be at least partially prelithiated prior to a first electrochemical cycle after battery assembly, or alternatively prior to battery assembly. That is, some lithium may be incorporated into the lithium storage layer to form a lithiated storage layer even prior to a first battery cycle. In some embodiments, the lithiated storage layer may break into smaller structures, including but not limited to platelets, that remain electrochemically active and continue to reversibly store lithium. Note that “lithiated storage layer” simply means that at least some of the potential storage capacity of the lithium storage layer is filled, but not necessarily all. In some embodiments, the lithiated storage layer may include lithium in a range of 1% to 5% of the theoretical lithium storage capacity of the lithium storage layer, alternatively 5% to 10%, alternatively 10% to 15%, alternatively 15% to 20%, alternatively, 20% to 30%, alternatively 30% to 40%, alternatively 40% to 50%, alternatively 50% to 60%, alternatively 60% to 70%, alternatively 70% to 80%, alternatively 80% to 90%, alternatively 90% to 100%, or any combination of ranges thereof. In some embodiments, a surface layer may capture some of the lithium, and one may need to account for such capture to achieve the desired lithium range in the lithiated storage layer.

In some embodiments prelithiation may include depositing lithium metal over the lithium storage layer, e.g., a continuous porous lithium storage layer, alternatively between one or more lithium storage sublayers, or both, e.g., by evaporation, e-beam or sputtering. Alternatively, prelithiation may include contacting the anode with a reductive lithium organic compound, e.g., lithium naphthalene, n-butyllithium or the like. In some embodiments, prelithiation may include incorporating lithium by electrochemical reduction of lithium ion in prelithiation solution. In some embodiments, prelithiation may include a thermal treatment to aid the diffusion of lithium into the lithium storage layer.

In some embodiments the anode may be thermally treated prior to battery assembly. In some embodiments, thermally treating the anode may improve adhesion of the various layers or electrical conductivity, e.g., by inducing migration of metal from the current collector or atoms from the optional supplemental layer into the lithium storage layer.

In some embodiments, the lithium storage layer, e.g., a continuous porous lithium storage layer, includes at least 0.05 atomic % of one or more transition metals, alternatively at least 0.1 atomic %, alternatively at least 0.2 atomic %, alternatively at least 0.5 atomic %, alternatively at least 1 atomic % copper. In some embodiments, the lithium storage layer, e.g., a continuous porous lithium storage layer, includes less than about 10 atomic % of one or more transition metals, alternatively less than 5 atomic %, alternative less than 2 atomic %, alternatively less than 1 atomic %, alternatively less than 0.5 atomic %, alternatively less than 3 atomic %. In some embodiments, the lithium storage layer, e.g., a continuous porous lithium storage layer, may include one or more transition metals in an atomic % range of 0.05-0.1%, alternatively 0.1-0.2%, alternatively 0.2-0.5%, alternatively 0.5-1%, alternatively 1-2%, alternatively 2-3%, alternatively 3-5%, alternatively 5-7%, alternatively 7-10%, or any combination of ranges thereof. In some embodiments, the aforementioned ranges of atomic % the transition metal(s) may correspond to a cross-sectional area of the lithium storage layer of at least 1 μm², which may be measured, e.g., by energy dispersive x-ray spectroscopy (EDS). In some embodiments, the transition metal atomic % values above may represent the atomic % of one transition metal or alternatively may correspond to the combined atomic % when there is mixture of transition metals. Some non-limiting examples of transition metals that may be present in the lithium storage layer include copper, nickel, titanium, vanadium, and molybdenum. In some embodiments, there is a gradient where the concentration of the transition metal in portions of the lithium storage layer near the current collector is higher than portions further from the current collector. In some embodiments, the lithium storage layer, e.g., a continuous porous lithium storage layer, may include a transition metal that is the same as a transition metal found in the electrically conductive layer or the surface layer transition metallate. In some cases, the one or more transition metals may be provided in the lithium storage layer by thermal treatments to cause migration of the metal into the lithium storage layer, but other methods may be used, such as co-deposition of the lithium storage material and the metal.

In some embodiments, thermally treating the anode may be done in a controlled environment having a low oxygen and water (e.g., less than 10 ppm or partial pressure of less than 0.1 Torr, alternatively less than 0.01 Torr content to prevent degradation). In some embodiments, anode thermal treatment may be carried out using an oven, infrared heating elements, contact with a hot plate or exposure to a flash lamp. The anode thermal treatment temperature and time depend on the materials of the anode. In some embodiments, anode thermal treatment includes heating the anode to a temperature of at least 50° C., optionally in a range of 50° C. to 950° C., alternatively 100° C. to 250° C., alternatively 250° C. to 350° C., alternatively 350° C. to 450° C., alternatively 450° C. to 550° C., alternatively 550° C. to 650° C., alternatively 650° C. to 750° C., alternatively 750° C. to 850° C., alternatively 850° C. to 950° C., or a combination of these ranges. In some embodiments, the thermal treatment may be applied for a time period of 0.1 to 120 minutes.

In some embodiments one or more processing steps described above may be performed using roll-to-roll methods wherein the electrically conductive layer or current collector is in the form of a rolled film, e.g., a roll of metal foil, mesh or fabric.

### Battery Features

The preceding description relates primarily to the anode/negative electrode of a lithium-ion battery (LIB). The LIB typically includes a cathode/positive electrode, an electrolyte in contact with both the anode and cathode, and a current separator (if not using a solid-state electrolyte) disposed between the anode and cathode. As is well known, batteries can be formed into multilayer stacks of anodes and cathodes with an intervening separator. In some cases, multilayer stacks may have active material coated on both sides of the respective current collectors of the anode and cathode. Alternatively, anode/cathode stacks can be formed into a so-called jelly-roll. Such structures are provided into an appropriate housing having desired electrical contacts.

### Cathode

Positive electrode (cathode) materials include, but are not limited to, lithium metal oxides or compounds (e.g., LiCoO₂ (aka “LCO”), LiFePO₄ (aka “LFP”), LiNiₓMnₓO₄ (aka “LNMO”), LiMnO₂, LiNiO₂, LiMn₂O₄ (aka “LMO”), LiCoPO₄, LiNiₓCo_{y}Mn₂O₂ (aka “NMC”), LiNiₓCo_{y}Al₂O₂ (aka “NCA”), LiFe₂(SO₄)₃, or Li₂FeSiO₄), carbon fluoride, metal fluorides such as iron fluoride (FeF₃), metal oxide, sulfur, selenium and combinations thereof. Cathode active materials may operate, e.g., by intercalation, conversion, or a combination. Cathode active materials are typically provided on, or in electrical communication with, an electrically conductive cathode current collector. In some embodiments, a cathode current collector may include a metal foil, mesh, or sheet of a conductive material such as aluminum. In some cases, a cathode current collector may include a metal coating such as aluminum provided over an electrically insulating polymer (one or both sides). In some cases, the cathode current collector may be a film, paper, fiber, or sheet that includes an electrically conductive carbon, such as carbon black, carbon nanotubes, graphene, graphene oxide, reduced graphene oxide, and graphite. In some embodiments, the electrically conductive layer may be in the form of a foil, a mesh, or sheet of conductive material. In some embodiments, a cathode current collector may include a an electrically conductive layer and a transition metallate surface layer according to the present application.

### Current Separator

The current separator allows ions to flow between the anode and cathode but prevents direct electrical contact. Such separators are typically porous sheets, and along with electrolyte, occupies at least a portion of the space between the anode and cathode. Depending on cell design, a current separator may be in physical contact with the cathode, the anode, both the anode and cathode, or neither the anode or cathode. Non-aqueous lithium-ion separators are single layer or multilayer polymer sheets, typically made of polyolefins, especially for small batteries. Most commonly, these are based on polyethylene or polypropylene, but polyethylene terephthalate (PET) and polyvinylidene fluoride (PVdF) can also be used. For example, a separator can have >30% porosity, low ionic resistivity, a thickness of ˜10 to 50 μm and high bulk puncture strengths. Separators may alternatively include glass materials, ceramic materials, a ceramic material embedded in a polymer, a polymer coated with a ceramic, or some other composite or multilayer structure, e.g., to provide higher mechanical and thermal stability.

### Electrolyte

The electrolyte in lithium ion cells may be a liquid, a solid, or a gel. A typical liquid electrolyte comprises one or more solvents and one or more salts, at least one of which includes lithium. During the first few charge cycles (sometimes referred to as formation cycles), the organic solvent and/or the electrolyte may partially decompose on the negative electrode surface to form an SEI (Solid-Electrolyte-Interphase) layer. The SEI is generally electrically insulating but ionically conductive, thereby allowing lithium ions to pass through. The SEI may lessen decomposition of the electrolyte in the later charging cycles.

Some non-limiting examples of non-aqueous solvents suitable for some lithium ion cells include the following: cyclic carbonates (e.g., ethylene carbonate (EC), fluoroethylene carbonate (FEC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC, also commonly abbreviated EMC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

Non-aqueous liquid solvents can be employed in combination. Examples of these combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In some embodiments, a cyclic carbonate may be combined with a linear ester. Moreover, a cyclic carbonate may be combined with a lactone and a linear ester. In some embodiments, the weight ratio, or alternatively the volume ratio, of a cyclic carbonate to a linear ester is in a range of 1:9 to 10:1, alternatively 2:8 to 7:3.

A salt for liquid electrolytes may include one or more of the following non-limiting examples: LiPF₆, LiBF₄, LiClO₄LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), LiFSI(lithium bis(fluorosulfonyl)imide), LiTDI(lithium 4,5-dicyano-2-(trifluoromethyl)imidazole), and combinations thereof.

In some embodiments, the total concentration of a lithium salt in a liquid non-aqueous solvent (or combination of solvents) is at least 0.3 M, alternatively at least 0.7 M. The upper concentration limit may be driven by a solubility limit and operational temperature range. In some embodiments, the concentration of salt is no greater than about 2.5 M, alternatively no more than about 1.5 M. In some embodiments, the electrolyte may include a saturated solution of a lithium salt and excess solid lithium salt.

In some embodiments, the battery electrolyte includes a non-aqueous ionic liquid and a lithium salt. Additives may be included in the electrolyte to serve various functions such as to stabilize the battery. For example, additives such as polymerizable compounds having an unsaturated double bond may be added to stabilize or modify the SEI. Certain amines or borate compounds may act as cathode protection agents. Lewis acids can be added to stabilize fluorine-containing anion such as PF₆. Safety protection agents include those to protect overcharge, e.g., anisoles, or act as fire retardants, e.g., alkyl phosphates.

A solid electrolyte may be used without the separator because it serves as the separator itself. It is electrically insulating, ionically conductive, and electrochemically stable. In the solid electrolyte configuration, a lithium containing salt, which could be the same as for the liquid electrolyte cells described above, is employed but rather than being dissolved in an organic solvent, it is held in a solid polymer composite. Examples of solid polymer electrolytes may be ionically conductive polymers prepared from monomers containing atoms having lone pairs of electrons available for the lithium ions of electrolyte salts to attach to and move between during conduction, such as polyvinylidene fluoride (PVDF) or chloride or copolymer of their derivatives, poly(chlorotrifluoroethylene), poly(ethylene-chlorotrifluoro-ethylene), or poly(fluorinated ethylene-propylene), polyethylene oxide (PEO) and oxymethylene linked PEO, PEO-PPO-PEO crosslinked with trifunctional urethane, poly(bis(methoxy-ethoxy-ethoxide))-phosphazene (MEEP), triol-type PEO crosslinked with difunctional urethane, poly((oligo)oxyethylene)methacrylate-co-alkali metal methacrylate, polyacrylonitrile (PAN), polymethylmethacrylate (PMMA), polymethylacrylonitrile (PMAN), polysiloxanes and their copolymers and derivatives, acrylate-based polymer, other similar solvent-free polymers, combinations of the foregoing polymers either condensed or cross-linked to form a different polymer, and physical mixtures of any of the foregoing polymers. Other less conductive polymers that may be used in combination with the above polymers to improve the strength of thin laminates include polyester (PET), polypropylene (PP), polyethylene naphthalate (PEN), polyvinylidene fluoride (PVDF), polycarbonate (PC), polyphenylene sulfide (PPS), and polytetrafluoroethylene (PTFE). Such solid polymer electrolytes may further include a small amount of an organic solvent such as those listed above. The polymer electrolyte may be an ionic liquid polymer. Such polymer-based electrolytes can be coated using any number of conventional methods such as curtain coating, slot coating, spin coating, inkjet coating, spray coating or other suitable method.

In some embodiments, the original, non-cycled anode may undergo structural or chemical changes during electrochemical charging/discharging, for example, from normal battery usage or from an earlier “electrochemical formation step”. As is known in the art, an electrochemical formation step is commonly used to form an initial SEI layer and involves relatively gentle conditions of low current and limited voltages. The modified anode prepared in part from such electrochemical charging/discharging cycles may still have excellent performance properties, despite such structural and/or chemical changes relative to the original, non-cycled anode. In some embodiments, the lithium storage layer of the cycled anode may no longer appear as a continuous layer, and instead, appear as separated pillars or islands, generally with an average height-to-width aspect ratio of less than 2. While not being bound by theory, in the case of amorphous silicon, it may be that small amounts delaminate upon cycling at high stress areas. Alternatively, or in addition, it may be that structural changes upon lithiation and delithiation are non-symmetrical resulting in such islands or pillars.

In some embodiments, electrochemical cycling conditions may be set to utilize only a portion of the theoretical charge/discharge capacity of silicon (3600 mAh/g). In some embodiments, electrochemical charging/discharging cycles may be set to utilize 400-600 mAh/g, alternatively 600-800 mAh/g, alternatively 800-1000 mAh/g, alternatively 1000-1200 mAh/g, alternatively 1200-1400 mAh/g, alternatively 1400-1600 mAh/g, alternatively 1600-1800 mAh/g, alternatively 1800-2000 mAh/g, alternatively 2000-2200 mAh/g, alternatively 2200-2400 mAh/g, alternatively 2400-2600 mAh/g, alternatively 2600-2800 mAh/g, alternatively 2800-3000 mAh/g, alternatively 3000-3200 mAh/g, alternatively 3200-3400 mAh/g, or any combination of ranges thereof.

### EXAMPLES

### PECVD

An Oxford Plasmalabs System 100 PECVD tool was used to deposit silicon onto various current collectors. Unless otherwise noted, depositions were conducted at about 300° C. at an RF power in a range of about 225 to 300 W. The deposition gas was a mixture of silane and argon in a gas flow ratio of about 1 to 12, respectively. Unless otherwise noted, the deposition time was 60 minutes which provided about a 10-12 μm thick, porous amorphous silicon layer on the current collector.

### Comparative Anode C-1

Current collector sample CC-1 was a 26 μm thick copper foil having surface roughness of Rₐ=0.164 μm and R_{z}=1.54 μm. CC-1 did not have a surface layer of the present disclosure. An attempt was made to deposit silicon onto one side of CC-1 using PECVD conditions noted above. Silicon deposition was stopped after 30 minutes in this comparative example. The silicon did not adhere sufficiently for electrochemical testing and no further characterization was made.

### Comparative Anode C-2

In this test, it is shown that electrodepositing copper roughening features alone is generally not sufficient to improve adhesion of silicon. Copper Foil A (high purity copper) was 25 μm thick, a tensile strength of about 275 MPa, and a starting surface roughness Rₐ of 167 nm. Copper Foil A was cleaned first in acetone then in IPA with sonication for 10 minutes then rinsed with DI water. The foil was treated with 10% concentrated sulfuric acid for 30 seconds, rinsed in DI water, and placed in an electrodeposition fixture. The fixture was immersed in a bath of 0.01M CuSO₄ (aq) with 1M H₂SO₄. Electrodepositions on metal foil were performed using a plating fixture such that just one side of the metal foil was exposed for the electrodeposition. The counter electrode was platinum/niobium mesh spaced 1.9 cm from the metal foil. Current was supplied to the foil at 100 mA/cm² for 100 sec (conditions suitable to deposit copper roughening features), the foil was removed and rinsed in DI water and air dried. The surface roughness Rₐ was 246 nm and surface roughness R_{z} was 2.3 μm. When silicon was deposited by PECVD as described above, it easily flaked off.

### Example Anodes

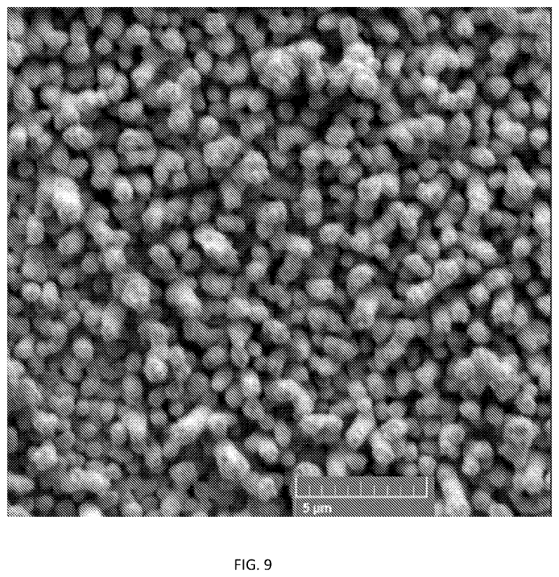

In some tests, current collectors were prepared from Copper Foil B (rolled C70250 alloy sometimes referred to as CuNi3Si) which was 20 μm thick and had a tensile strength in a range of about 690 to 860 MPa, a yield strength of greater than about 655 MPa, and an initial surface roughness Rₐ of 280 nm. Copper Foil B was first cleaned by rubbing both sides of the foil with a melamine-formaldehyde based foam soaked in tri(propylene glycol)methyl ether in order to remove an organic anticorrosion layer. Copper Foil B was sonicated in acetone for 10 minutes, and then ethyl alcohol for 10 minutes. The sample was rinsed in DI water, immersed in 10% sulfuric acid for 30 seconds and rinsed with water. The foil was placed in an electrodeposition fixture designed for two-sided deposition. The fixture was immersed in a bath of 0.01M CuSO₄ (aq) with 1M H₂SO₄. Current was supplied to the foil at 20 mA/cm² for 500 sec (conditions suitable to deposit copper roughening features). The fixture was then placed into a bath of 0.4M CuSO₄ (aq) and ₁M H₂SO₄ and supplied with a current density of ₁₀ mA/cm² for a period of 100 seconds. This second copper deposition overcoated the copper roughening features and may help anchor them to the foil. The fixture was then removed rinsed with DI water. Modified Copper Foil B′ was then used in subsequent treatments to form surface layers as described below. In some cases, Copper Foil B′ may have an SEM cross-section similar to that shown in FIG. 6A, or in perspective view, as shown in FIG. 9 which was fabricated in a similar manner.

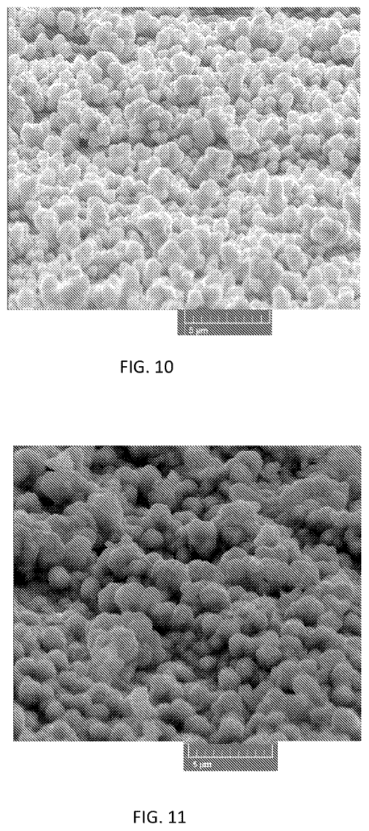

In some tests, current collectors were prepared from Copper Foil C which included copper roughening features and a chromate anticorrosion coating, was 18 μm thick, had a tensile strength of about 414 MPa, and a surface roughness Rₐ of 406 nm. An SEM of Copper Foil C is shown in FIG. 10 and the copper roughening features are evident which may be characterized as nodular or nanopillar features. Copper Foil C may have an SEM cross-section similar to that shown in FIG. 6B. To clean and remove the chromate anticorrosion coating, Copper Foil C was sonicated in acetone for 10 minutes, and then ethyl alcohol for 10 minutes. The sample was rinsed in DI water, immersed in 10% sulfuric acid for 30 seconds and rinsed with water to form Copper Foil C′. Copper Foil C′ was then used in subsequent treatments to form surface layers as described below. Although no SEM was taken of Copper Foil C′, it is expected to be similar to that of Copper Foil C.

Note that neither Copper Foil B′ nor C′ themselves (without further modification) is commercially viable as a current collector because of the formation of a non-uniform copper oxide layer at the surface over time due to lack of any anticorrosion coatings. In some cases, at elevated temperatures and reduced pressures as are sometimes used in PECVD, the copper oxide may cause potential contamination of the PECVD equipment. Further, although copper oxide may allow some adherence of silicon, the non-uniformity may cause quality control issues. In some embodiments, surface layers of the present disclosure may also act as anticorrosion coatings. Note also that all of the current collectors of the Example Anodes below had a surface roughness of Rₐ>250 nm.

### Example Anode E-1

Copper Foil C′ was treated to form a surface layer using a coating solution containing vanadate as the transition metallate. Specifically, treatment included immersion of Copper Foil C′ into a solution containing 10 g/L H₃PO₄, 4 g/L NaVO₃, 7 g/L ZnCl₂ and 2 mL/L of ammonia solution at 50° C. for 5 minutes with no forced convection. The sample was then rinsed with DI water and allowed to dry in air. Silicon was deposited onto the surface layer-modified current collector using conditions described previously.

### Example Anode E-2

This sample was similar to E-1 except that the immersion time was 10 minutes instead of 5 minutes.

### Example Anode E-3

This sample was similar to E-1 except that the immersion time was 15 minutes instead of 5 minutes. A chemical analysis of the treated foil prior to silicon deposition showed that the surface layer included about 350 mg/m² of vanadium and about 150 mg/m² of zinc. An SEM of the foil prior to silicon deposition is shown in FIG. 11. While the roughening features are still clearly evident, the coating process in this example noticeably modified their physical appearance so that they are more rounded and slightly wider than prior to the conversion process.

### Example Anode E-4

Copper Foil C′ was treated to form a surface layer using a coating solution containing vanadate and molybdate as the transition metallates. Specifically, treatment included immersion of Copper Foil C′ into a solution containing 10 g/L H₃PO₄, 4 g/L NaVO₃, 7 g/L ZnCl₂, 2 mL/L of ammonia solution and 1.8 g/L ammonium molybdate tetrahydrate at 50° C. for 5 minutes with no forced convection. The sample was then rinsed with DI water and allowed to dry in air. Silicon was deposited onto the surface layer-modified current collector using conditions described previously.

### Example Anode E-5

This sample was similar to E-4 except that the immersion time was 10 minutes instead of 5 minutes. A chemical analysis of the treated foil prior to silicon deposition showed that the surface layer included about 170 mg/m² of vanadium and about 90 mg/m² of zinc. Although molybdenum may be present, it was below the detection limit of about 7 mg/m².

### Example Anode E-6

Copper Foil C′ was treated to form a surface layer using a coating solution containing tungstate as the transition metallate. Specifically, treatment included immersion for 10 mins at room temperature in a sodium tungstate solution prepared by combining 49.48 g Na₂WO₄·2H₂O with DI water up to 500 ml which was adjusted to pH 3 with conc H₃PO₄. The foil was flipped every minute. The sample was then rinsed with DI water and allowed to dry in air. Chemical analysis found that tungsten in the surface layer was below the detection limit of about 30 mg/m². Silicon was deposited onto the surface layer-modified current collector using conditions described previously.

### Example Anode E-7

Copper Foil C′ was treated to form a surface layer using a coating solution containing tungstate as the transition metallate. Specifically, treatment included immersion for 10 min with flipping every minute, in a zinc/manganese/tungstate solution containing 10 g/L tungstate (WO₄) from sodium tungstate·2H₂O, 5 g/L manganese from manganese acetate·4H₂O, and 2 g/L zinc from zinc acetate·2H₂O, all in DI water, adjusted to pH 2 with H₂SO₄. The sample was then rinsed with DI water and allowed to dry in air. Silicon was deposited onto the surface layer-modified current collector using conditions described previously.

### Example Anode E-8

This sample was similar to E-7 except that the temperature of the solution was at 60° C.

### Example Anode E-9

This sample was similar to E-8 except that Copper Foil B′ was used instead of Copper Foil C′

### Example Anode E-10

Copper Foil C′ was treated to form a surface layer using a coating solution containing molybdate as the transition metallate. Specifically, treatment included immersion at room temperature for 30 minutes with stirring in a zinc calcium phosphomolybdate solution containing 81 mg/L Ca from calcium acetate, 97 mg/L Zn from zinc acetate, 190 mg/L MoO₄²⁻from sodium molybdate, 3.27 mg/L PO₄³⁻from sodium phosphate, all dissolved in 400 ml DI water, pH adjusted to 7.65, then diluted up to 500 ml. The sample was then rinsed with DI water and allowed to dry in air. Silicon was deposited onto the surface layer-modified current collector using conditions described previously.

### Example Anode E-11

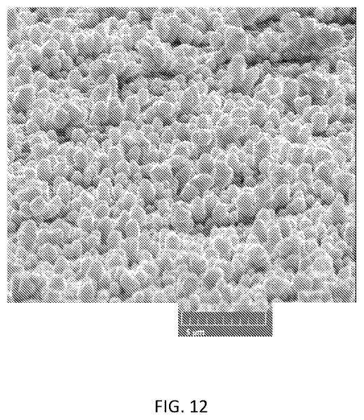

This sample was similar to E-10 except that the temperature of the solution was at 60° C. and the immersion time was 10 minutes. Chemical analysis of the treated foil found that molybdenum in the surface layer was below the detection limit of about 7 mg/m². An SEM of the foil prior to silicon deposition is shown in FIG. 12. The roughening features appear very similar to that of FIG. 9 suggesting that the coating process forms a relatively thin surface layer, which is also consistent with the chemical analysis.

### Example Anode E-12

Copper Foil C′ was treated to form a surface layer using a coating solution containing molybdate as the transition metallate. Specifically, treatment included immersion for 1 hour at room temperature in a 3 g/L PO₄³⁻/2 g/L MoO₄²⁻solution made by 2.242 g sodium phosphate plus 1.512 g sodium molybdate dissolved in DI water and pH adjusted to 7.6 with dilute H₃PO₄, and all diluted to 500 ml. The sample was then rinsed with DI water and allowed to dry in air. Silicon was deposited onto the surface layer-modified current collector using conditions described previously.

### Example Anode E-13

This sample was similar to E-12 except that the temperature of the solution was at 60° C. and immersion time was 60 minutes.

### Example Anode E-14

Copper Foil C′ was treated to form a surface layer using a coating solution containing niobate as the transition metallate. Specifically, treatment included immersion at 60° C. for 5 min in an ammonium niobate oxalate solution prepared by dissolving 32.6 g C₄H₄NNbO₉·XH₂O per liter of solution. The solution pH was 0.9. The sample was then rinsed with DI water and allowed to dry in air. Silicon was deposited onto the surface layer-modified current collector using conditions described previously.

### Example Anode E-15

This sample was similar to E-14 except that the immersion time was 10 minutes.

### Example Anode E-16

Copper Foil C′ was treated to form a surface layer using a coating solution containing hexafluorotitanate as the transition metallate. Specifically, treatment included immersion at 60° C. for 8 min in a solution containing 12.1 g/L of K₂TiF₆ at pH 2.5 (via HNO₃ addition). Silicon was deposited onto the surface layer-modified current collector using conditions described previously except that the Si deposition time was 40 minutes rather than 60 minutes which provided about a 7-8 μm thick, porous amorphous silicon layer current collector.

### Example Anode E-17

This sample similar to E-16 but prepared on a different day.

### Example Anode E-18

This sample was similar to E-12 but prepared on a different day.

### Example Anode E-19

This sample was similar to E-10 except that the immersion time was 5 minutes.

### Example Anode E-20

This sample was similar to E-19 except that the pH was adjusted to 3.5 and the immersion time was 10 minutes.

### Example Anode E-21

This sample was similar to E-12 except the immersion time was 1 minute.

### Example Anode E-22

This sample was similar to E-21 except the immersion time was 35 seconds.

### Example Anode E-23

This sample was similar to E-21 except that the pH was adjusted to 3.5 and the immersion time was 4 minutes.

### Example Anode E-24

This sample was similar to E-23 except that the temperature was raised to 60° C. and the immersion time was 5 minutes.

### Example Anode E-25

This sample was similar to E-23 except that the temperature was raised to 45° C. and the immersion time was 9 seconds.

### Example Anode E-26

This sample was similar to E-25 except that the temperature was raised to 45° C. and the immersion time was 18 seconds.

### Electrochemical Testing-Half Cells

Half cells were constructed using a 0.80 cm diameter punch of each anode. Lithium metal served as the counter electrode which was separated from the test anode using Celgard™ separators. The standard electrolyte solution (“standard”) included: a) 88 wt. % of 1.2 M LiPF₆ in 3:7 EC:EMC (weight ratio); b) 10 wt. % FEC; and 2 wt. % VC. Anodes first underwent an electrochemical formation step. As is known in the art, the electrochemical formation step is used to form an initial SEI layer. Relatively gentle conditions of low current and/or limited voltages may be used to ensure that the anode is not overly stressed. In the present examples, electrochemical formation included several cycles over a wide voltage range (0.01 or 0.06 to 1.2V) at C-rates ranging from C/20 to C/10. The total active silicon (mg/cm²) available for reversible lithiation and total charge capacity (mAh/cm²) were determined from the electrochemical formation step data. Formation losses were calculated by dividing the change in active areal charge capacity (initial first charge capacity minus last formation discharge capacity) by the initial areal first charge capacity. While silicon has a theoretical charge capacity of about 3600 mAh/g when used in lithium-ion batteries, it has been found that cycle life may improve if only a portion of the full capacity is used. For all anodes, the performance cycling was set to use a portion of the total capacity, typically in a range of about 1000-1600 mAh/g. The performance cycling protocol for Examples 1-16a, and 17 included 1 C charging (considered aggressive in the industry) and 1 C discharging (also considered aggressive in the industry) to roughly a 5% state of charge. A 10-minute rest was provided between charging and discharging cycles. In Example 18a, the protocol was similar but used C/3 discharging to roughly a 15% state of charge. The cycling protocol for the other examples included 3.2 C charging (considered very aggressive in the industry) and C/3 discharging to roughly a 15% state of charge. A 10-minute rest was provided between charging and discharging cycles.

Table 1 summarizes the properties and cycling performance of the Example Anodes. In some commercial uses, the anodes should have a charge capacity of at least 1.5 mAh/cm² and be able to charge at a rate of IC with a cycle life of at least 100 cycles, meaning that the charge capacity should not fall lower than 80% of the initial charge capacity after 100 cycles. The number of cycles it takes for an anode to fall below 80% of the initial charge is commonly referred to as its “80% SoH (“state-of-health”) cycle life”. All the Example Anodes were found to meet and exceed the above criteria, even with aggressive 1 C discharging. When allowed to discharge at C/3, many examples have a cycle life that exceeded 1000 cycles, at which point testing was stopped. Examples 25 and 26 were past 360 cycles and still cycling around the time of this filing. It is noted also that the formation losses for all of the example anodes were less than about 25%, which is generally acceptable. The majority of example anodes had formation losses of less than about 15% and many were even less than 10%. In general, formation losses of less than 15% are considered very good and may sometimes be indicative of a highly stable a-Si anode. It has often been observed that high formation losses are sometimes indicative of an unstable anode, although there are exceptions. It is noted that the vanadate-treated examples have generally higher formation losses than the other samples. In this case, formation loss may be due to some irreversible reactions involving the surface layer (which may be thicker for the vanadate-treated samples than the other samples) and may not necessarily signify low stability.

Surprisingly, current collectors with very short surface layer treatment times, e.g., of 1 min or less (down to even just 9 seconds) were found to provide effective surface layers. Although long treatments such as 1 hour can also be effective, reducing the treatment time may reduce manufacturing costs and be more compatible with allow roll-to-roll processing. In some cases, the surface layer treatment time may be 10 minutes or less, alternatively 5 minutes or less, alternatively 1 minute or less, alternatively 30 seconds or less, alternatively 10 seconds or less.

In some embodiments, anodes of the present disclosure may provide at least a charge capacity of at least 2.0 mAh/cm² and an 80% SoH cycle life of at least 100 cycles at a charge rate of at least 1 C and a discharge rate of at least 1 C. In some embodiments, anodes of the present disclosure may have a cycle life of at least 200 cycles, alternatively at least 300, 400, or 500 cycles when tested at about 2 mAh/cm² at 1 C charge and 1 C discharge.

In some embodiments, anodes of the present disclosure may provide at least a charge capacity of at least 1.5 mAh/cm² and an 80% SoH cycle life of at least 300 cycles at a charge rate of at least 3 C and a discharge rate of at least C/3, alternatively at least 400 cycles, 500 cycles, 750 cycles, or 1000 cycles.

TABLE 1

| | | Surface Layer - | | | | |
|---|---|---|---|---|---|---|
| | | Transition Metallate | Cycling | Capacity | Form. | |
| Example | Anode | Treatment | protocol | (mAh/cm²) | Losses (%) | Cycle life |
| 1 | E-1 | Vanadate | 1 C-1 C | 2.09 | 25 | 280 |
| 2 | E-2 | Vanadate | 1 C-1 C | 2.29 | 19 | 322 |
| 3 | E-3 | Vanadate | 1 C-1 C | 2.29 | 24 | 310 |
| 4 | E-4 | Vanadate/Molybdate | 1 C-1 C | 2.09 | 22 | 352 |
| 5 | E-5 | Vanadate/Molybdate | 1 C-1 C | 2.09 | 20 | 296 |
| 6 | E-6 | Tungstate | 1 C-1 C | 2.29 | 8 | 294 |
| 7 | E-7 | Tungstate | 1 C-1 C | 2.29 | 10 | 332 |
| 8 | E-8 | Tungstate | 1 C-1 C | 2.29 | 2 | 267 |
| 9 | E-9 | Tungstate | 1 C-1 C | 2.29 | 16 | 324 |
| 10 | E-10 | Molybdate | 1 C-1 C | 2.29 | 9 | 394 |
| 11 | E-11 | Molybdate | 1 C-1 C | 2.29 | 5 | 324 |
| 12 | E-12 | Molybdate | 1 C-1 C | 2.29 | 11 | 397 |
| 13 | E-13 | Molybdate | 1 C-1 C | 2.29 | 7 | 207 |
| 14 | E-14 | Niobate | 1 C-1 C | 2.29 | 8 | 259 |
| 15 | E-15 | Niobate | 1 C-1 C | 2.29 | 10 | 359 |
| 16a | E-16 | Hexafluorotitanate | 1 C-1 C | 1.89 | 8 | 170 |
| 16b | E-16 | Hexafluorotitanate | 3.2 C-C/3 | 1.59 | 7 | >1000 |
| 17 | E-17 | Hexafluorotitanate | 1 C-1 C | 2.29 | 25 | 278 |
| 18a | E-18 | Molybdate | 1 C-C/3 | 2.09 | 12 | 930 |
| 18b | E-18 | Molybdate | 3.2 C-C/3 | 1.79 | 9 | 927 |
| 19 | E-19 | Molybdate | 3.2 C-C/3 | 1.89 | 6 | >1000 |
| 20 | E-20 | Molybdate | 3.2 C-C/3 | 1.89 | 9 | >1000 |
| 21 | E-21 | Molybdate | 3.2 C-C/3 | 1.89 | 9 | >1000 |
| 22 | E-22 | Molybdate | 3.2 C-C/3 | 1.89 | 8 | >1000 |
| 23 | E-23 | Molybdate | 3.2 C-C/3 | 1.89 | 11 | >1000 |
| 24 | E-24 | Molybdate | 3.2 C-C/3 | 1.89 | 11 | >1000 |
| 25 | E-25 | Molybdate | 3.2 C-C/3 | 1.89 | 7 | 361* |
| 26 | E-26 | Molybdate | 3.2 C-C/3 | 1.89 | 7 | 361* |

*Still cycling

Although the present anodes have been discussed with reference to batteries, in some embodiments the present anodes may be used in hybrid lithium-ion capacitor devices.

### ENUMERATED EMBODIMENTS

Still further embodiments herein include the following enumerated embodiments.
1. An anode for an energy storage device, the anode comprising:
a) a current collector comprising an electrically conductive layer and a surface layer disposed over and in contact with the electrically conductive layer, wherein the surface layer comprises a transition metallate other than chromate; and
b) a lithium storage layer overlaying and in contact with the surface layer, wherein the lithium storage layer:
   (i) has an average thickness of at least 1 μm,
   (ii) comprises at least 40 atomic % silicon, germanium, or a combination thereof, and
   (iii) is substantially free of carbon-based binders.
2. The anode of embodiment 1, wherein the current collector is characterized by a surface roughness Rₐ≥250 nm.
3. The anode of embodiment 1 or 2, where in the transition metallate comprises Sc, Ti, V, Mn, Fe, Co, Ni, Cu, Y, Zr, Nb, Mo, Ta, or W.
4. The anode according to any of embodiments 1-3, wherein the surface layer further comprises chromium.
5. The anode according to any of embodiments 1-4, wherein the transition metallate comprises an oxometallate
6. The anode of embodiment 5, wherein the oxometallate comprises a titanate, a vanadate, a molybdate, a tungstate, or a niobate.
7. The anode of embodiment 6, wherein the surface layer comprises a molybdate and phosphorous.
8. The anode of embodiment 7, wherein the phosphorous is in the form of phosphate.
9. The anode of embodiment 7 or 8, wherein the surface layer further comprises calcium and zinc.
10. The anode according to any of embodiments 1-9, wherein the surface layer comprises a compositional gradient.
11. The anode according to any of embodiments 1-10, wherein the electrically conductive layer comprises a plurality of electrically conductive nodular or nanopillar features and the surface layer is provided at least partially over the nodular or nanopillar features.
12. The anode of embodiment 11, wherein each of the plurality of the nodular or nanopillar features comprises copper.
13. The anode of embodiment 12, wherein the current collector comprises the plurality of electrically conductive nanopillar features, wherein each nanopillar feature is characterized by a height H, a base width B, and a maximum width W, and
wherein an average 20 μm long cross section of the current collector comprises:
   (i) at least five first-type nanopillars, each first-type nanopillar characterized by
      A) H in a range of 0.4 μm to 3.0 μm,
      B) B in a range of 0.2 μm to 1.0 μm,
      C) a W/B ratio in a range of 1 to 1.5,
      D) an H/B aspect ratio in a range of 0.8 to 4.0, and
      E) an angle of a longitudinal axis relative to the plane of the electrically conductive layer in a range of 60° to 90°.
14. The anode of embodiment 13, wherein the average 20 μm long cross section of the current collector further comprises:
   (ii) fewer than four second-type nanopillars, each second-type nanopillar characterized by
      A) H of at least 1.0 μm, and
      B) a W/B ratio greater than 1.5.
15. The anode according to any of embodiments 1-14, wherein the electrically conductive layer comprises nickel in a nickel layer.
16. The anode of embodiment 15, wherein the electrically conductive layer further comprises a metal interlayer interposed between the nickel layer and the surface layer.
17. The anode of embodiment 16, wherein the metal interlayer comprises copper.
18. The anode of embodiment 16 or 17, wherein the metal interlayer has an average interlayer thickness that is less than 50% of the total average thickness of the electrically conductive layer.
19. The anode according to any of embodiments 1-14, wherein the electrically conductive layer comprises copper.
20. The anode of embodiment 19, wherein the electrically conductive layer comprises a copper alloy comprising copper, magnesium, silver, and phosphorous.
21. The anode of embodiment 19, wherein the electrically conductive layer comprises a copper alloy comprising copper, iron, and phosphorous.
22. The anode of embodiment 19, wherein the electrically conductive layer comprises a copper alloy comprising brass or bronze.
23. The anode of embodiment 19, wherein the electrically conductive layer comprises a copper alloy comprising copper, nickel, and silicon.
24. The anode according to any of embodiments 1-14, wherein the electrically conductive layer comprises a titanium alloy.
25. The anode according to any of embodiments 1-24, wherein the current collector further comprises an insulating substrate and the electrically conductive layer overlays the insulating substrate.
26. The anode according to any of embodiments 1-14, wherein the electrically conductive layer comprises a mesh of electrically conductive carbon.
27. The anode of embodiment 26, wherein the electrically conductive layer further comprises a metal interlayer interposed between the mesh of electrically conductive carbon and the surface layer.
28. The anode of embodiment 27, wherein the metal interlayer comprises copper.
29. The anode according to any of embodiments 1-28, wherein the electrically conductive layer or current collector is characterized by a tensile strength of at least 400 MPa.
30. The anode according to any of embodiments 1-28, wherein the electrically conductive layer or current collector is characterized by a tensile strength of greater than 500 MPa.
31. The anode according to any of embodiments 1-28, wherein the electrically conductive layer or current collector is characterized by a tensile strength of at least 600 MPa.
32. The anode according to any of embodiments 1-28, wherein the electrically conductive layer or current collector is characterized by a tensile strength of at least 700 MPa.
33. The anode according to any of embodiments 1-32, wherein the electrically conductive layer comprises a roll-formed metal foil.
34. The anode according to any of embodiments 1-33, wherein the lithium storage layer is substantially free of high aspect ratio lithium storage nanostructures.
35. The anode according to any of embodiments 1-34, wherein the lithium storage layer is a continuous porous lithium storage layer.
36. The anode according to any of embodiments 1-35, wherein the lithium storage layer comprises a sub-stoichiometric nitride of silicon.
37. The anode according to any of embodiments 1-36, wherein the lithium storage layer comprises a sub-stoichiometric oxide of silicon.
38. The anode according to any of embodiments 1-37, wherein the lithium storage layer comprises at least 80 atomic % of amorphous silicon.
39. The anode according to any of embodiments 1-38, wherein the lithium storage layer comprises at least 90 atomic % of amorphous silicon.
40. The anode of embodiment 38 or 39, wherein the density of the lithium storage layer is in a range of 1.1 to 2.25 g/cm³.
41. The anode according to any of embodiments 1-37, wherein the lithium storage layer comprises up to 30% of nano-crystalline silicon.
42. The anode according to any of embodiments 1-41, wherein the lithium storage layer comprises columns of silicon nanoparticle aggregates.
43. The anode according to any of embodiments 1-42, wherein the lithium storage layer further comprises boron, phosphorous, carbon, sulfur, fluorine, aluminum, gallium, indium, arsenic, antimony, or bismuth, or a combination thereof.
44 The anode according to any of embodiments 1-43, wherein the lithium storage layer further comprises a transition metal distributed through at least a portion of the lithium storage layer.
45. The anode of embodiment 44, wherein the transition metal comprised in the lithium storage layer is present at a total concentration in a range of 0.5 to 5.0 atomic %.
46. The anode of embodiment 44 or 45, wherein the transition metal element comprised in the lithium storage layer is also present in the electrically conductive layer or surface layer.
47. The anode of embodiments 46, wherein the transition metal comprised in the lithium storage layer has a higher concentration near the surface layer than away from the surface layer
48. The anode according to any of embodiments 1-47, wherein the lithium storage layer has an average thickness of at least 2.5 μm.
49. The anode according to any of embodiments 1-47, wherein the lithium storage layer has an average thickness of at least 5.0 μm.
50. The anode according to any of embodiments 1-47, wherein the lithium storage layer has an average thickness of at least 7.0 μm.
51. The anode according to any of embodiments 1-47, wherein the lithium storage layer has an average thickness in a range of 2.5 μm to 20 μm.
52. The anode according to any of embodiments 1-51, wherein the lithium storage layer includes less than 5 atomic % carbon.
53. The anode according to any of embodiments 1-52, wherein the lithium storage layer includes less than 1 atomic % carbon.
54. The anode according to any of embodiments 1-53, wherein the lithium storage layer is substantially free of high aspect ratio nanostructures.
55. The anode according to any of embodiments 1-54 wherein the surface layer is formed non-electrolytically by a conversion coating process.
56. The anode according to any of embodiments 1-55, wherein the surface layer does not include zinc.
57. The anode according to any of embodiments 1-56, wherein the surface layer does not include a silicon compound.
58. A method of making an anode for use in an energy storage device, the method comprising:
   a) providing a current collector comprising an electrically conductive layer and a surface layer overlaying and in contact with the electrically conductive layer, wherein the surface layer comprises, or is formed from, a transition metallate other than chromate; and
b) depositing a lithium storage layer onto the surface layer by a vapor deposition process,
wherein the lithium storage layer:
   (i) has an average thickness of at least 1 μm,
   (ii) comprises at least 40 atomic % silicon, germanium, or a combination thereof, and
   (iii) is in contact with the surface layer.
59. The method of embodiment 58, wherein the vapor deposition process is a chemical vapor deposition process.
60. The method of embodiment 58 or 59, wherein the vapor deposition process is a PECVD process.
61. The method of embodiment 60, wherein the PECVD process comprises forming a capacitively-coupled plasma or an inductively-coupled plasma.
62. The method of embodiment 60, wherein the PECVD process comprises a DC plasma source, an AC plasma source, an RF plasma source, a VHF plasma source, or a microwave plasma source.
63. The method of embodiment 60, wherein the PECVD process comprises magnetron-assisted RF PECVD.
64. The method of embodiment 60, wherein the PECVD process comprises expanding thermal plasma chemical vapor deposition.
65. The method of embodiment 60, wherein the PECVD process comprises hollow cathode PECVD.
66. The method according to any of embodiments 59-65, further comprising forming the lithium storage layer using a silane-based precursor gas.
67. The method of embodiment 66, wherein the silane-based precursor gas comprises silane (SiH₄).
68. The method of embodiment 66 or 67, wherein the silane-based precursor gas comprises dichlorosilane (H₂SiCl₂), monochlorosilane (H₃SiCl), trichlorosilane (HSiCl₃), silicon tetrachloride (SiCl₄), disilane, tetrafluorsilane, triethylsilane, or diethylsilane.
69. The method according to any of embodiments 66-68, further comprising adding hydrogen gas during the chemical vapor deposition.
70. The method of embodiment 69, wherein the ratio of the silane-based precursor gas to the hydrogen gas is 2 or less.
71. The method of embodiment 58, wherein the vapor deposition process comprises physical vapor deposition.
72. The method of embodiment 71, wherein the physical vapor deposition comprises sputtering.
73. The method according to any of embodiments 58-72, wherein the lithium storage layer includes less than 5 atomic % carbon.
74. The method according to any of embodiments 58-73, wherein the lithium storage layer is substantially free of high aspect ratio lithium storage nanostructures.
75. The method according to any of embodiments 58-74, wherein the lithium storage layer is a continuous porous lithium storage layer.
76. The method according to any of embodiments 58-75, wherein the lithium storage layer comprises a sub-stoichiometric nitride of silicon.
77. The method according to any of embodiments 58-76, wherein the lithium storage layer comprises a sub-stoichiometric oxide of silicon.
78. The method according to any of embodiments 58-77, wherein the lithium storage layer comprises at least 80 atomic % of amorphous silicon.
79. The method according to any of embodiments 58-78, wherein the lithium storage layer comprises at least 90 atomic % of amorphous silicon.
80. The method of embodiment 78 or 79, wherein the density of the lithium storage layer is in a range of 1.1 to 2.25 g/cm³.
81. The method according to any of embodiments 58-77, wherein the lithium storage layer comprises up to 30% of nano-crystalline silicon.
82. The method according to any of embodiments 58-81, wherein the lithium storage layer comprises columns of silicon nanoparticle aggregates.
83. The method according to any of embodiments 58-82, wherein the lithium storage layer has an average thickness of at least 2.5 μm.
84. The method according to any of embodiments 58-82, wherein the lithium storage layer has an average thickness of at least 5.0 μm.
85. The anode according to any of embodiments 58-82, wherein the lithium storage layer has an average thickness of at least 7.0 μm.
86. The anode according to any of embodiments 58-82, wherein the lithium storage layer has an average thickness in a range of 2.5 μm to 20 μm.
87. The method according to any of embodiments 58-86, further comprising doping the lithium storage layer with boron, phosphorous, carbon, sulfur, fluorine, aluminum, gallium, indium, arsenic, antimony, or bismuth, or a combination thereof.
88. The method according to any of embodiments 58-87, wherein the current collector is characterized by a surface roughness Ra ≥ 250 nm.
89. The method according to any of embodiments 58-88, wherein the transition metallate comprises Sc, Ti, V, Mn, Fe, Co, Ni, Cu, Zn, Y, Zr, Nb, Mo, Ta, or W.
90. The method according to any of embodiments 58-89, wherein the surface layer further comprises chromium.
91. The method according to any of embodiments 58-90, wherein the transition metallate comprises an oxometallate
92. The method of embodiment 91, wherein the oxometallate comprises a titanate, a vanadate, a molybdate, a tungstate, or a niobate.
93. The method of embodiment 92, wherein the surface layer comprises a molybdate and phosphorous.
94. The method of embodiment 93, wherein the phosphorous is in the form of phosphate.
95. The method of embodiment 93 or 94, wherein the surface layer further comprises calcium and zinc.
96. The method according to any of embodiments 58-95, wherein the surface layer comprises a compositional gradient.
97. The method according to any of embodiments 58-96, wherein the electrically conductive layer comprises a plurality of electrically conductive nodular or nanopillar features and the surface layer is provided at least partially over the nodular or nanopillar features.
98. The method of embodiment 97, wherein each of the plurality of the nodular or nanopillar features comprises copper.
99. The method of embodiment 98, wherein the current collector comprises the plurality of electrically conductive nanopillar features, wherein each nanopillar feature is characterized by a height H, a base width B, and a maximum width W, and
wherein an average 20 μm long cross section of the current collector comprises:
   (i) at least five first-type nanopillars, each first-type nanopillar characterized by
      A) H in a range of 0.4 μm to 3.0 μm,
      B) B in a range of 0.2 μm to 1.0 μm,
      C) a W/B ratio in a range of 1 to 1.5,
      D) an H/B aspect ratio in a range of 0.8 to 4.0, and
      E) an angle of a longitudinal axis relative to the plane of the electrically conductive layer in a range of 60° to 90°; and
100. The method of embodiment 99, wherein the average 20 μm long cross section of the current collector is further comprises:
   (ii) fewer than four second-type nanopillars, each second-type nanopillar characterized by
      A) H of at least 1.0 μm, and
      B) a W/B ratio greater than 1.5.
101. The method according to any of embodiments 58-100, wherein the electrically conductive layer comprises nickel in a nickel layer.
102. The method of embodiment 101, wherein the electrically conductive layer further comprises a metal interlayer interposed between the nickel layer and the surface layer.
103. The method of embodiment 102, wherein the metal interlayer comprises copper.
104. The method of embodiment 102 or 103, wherein the metal interlayer has an average interlayer thickness that is less than 50% of the total average thickness of the electrically conductive layer.
105. The method according to any of embodiments 58-100, wherein the electrically conductive layer comprises copper.
106. The method of embodiment 105, wherein the electrically conductive layer comprises a copper alloy comprising copper, magnesium, silver, and phosphorous.
107. The method of embodiment 105, wherein the electrically conductive layer comprises a copper alloy comprising copper, iron, and phosphorous.
108. The method of embodiment 105, wherein the electrically conductive layer comprises a copper alloy comprising brass or bronze.
109. The method of embodiment 105, wherein the electrically conductive layer comprises a copper alloy comprising copper, nickel, and silicon.
110. The method according to any of embodiments 58-100, wherein the electrically conductive layer comprises a titanium alloy.
111. The method according to any of embodiments 58-110, wherein the current collector further comprises an insulating substrate and the electrically conductive layer overlays the insulating substrate.
112. The method according to any of embodiments 58-100, wherein the electrically conductive layer comprises a mesh of electrically conductive carbon.
113. The method of embodiment 112, wherein the electrically conductive layer further comprises a metal interlayer interposed between the mesh of electrically conductive carbon and the surface layer.
114. The method of embodiment 113, wherein the metal interlayer comprises copper.
115. The method according to any of embodiments 58-114, wherein the electrically conductive layer or current collector is characterized by a tensile strength of at least 400 MPa.
116. The method according to any of embodiments 58-114, wherein the electrically conductive layer or current collector is characterized by a tensile strength of greater than 500 MPa.
117. The method according to any of embodiments 58-114, wherein the electrically conductive layer or current collector is characterized by a tensile strength of at least 600 MPa.
118. The method according to any of embodiments 58-114, wherein the electrically conductive layer or current collector is characterized by a tensile strength of at least 700 MPa.
119. The method according to any of embodiments 58-118, wherein the electrically conductive layer comprises a roll-formed metal foil.
120. The method according to any of embodiments 58-119, wherein the surface layer is formed non-electrolytically by a conversion coating process.
121. The method according to any of embodiments 58-120, wherein the surface layer does not include zinc.
122. The method according to any of embodiments 58-121, wherein the surface layer does not include a silicon compound.
133. A method of making a current collector for use in an energy storage device, the current collector comprising an electrically conductive layer and a surface layer, the method comprising:
forming the surface layer on the electrically conductive layer by contacting the electrically conductive layer with a mixture comprising a transition metallate compound other than a chromate and one or more mixture solvents,
wherein:
(i) the current collector is characterized by a surface roughness Rₐ≥250 nm, and
(ii) the mixture is substantially free of a silicon compound,
134. The method of embodiment 133, wherein the electrically conductive layer comprises copper.
135. The method of embodiment 133 or 134, wherein the electrically conductive layer comprises a plurality of electrically conductive nodular or nanopillar features disposed over the electrically conductive layer and the surface layer is formed over the nodular or nanopillar features.
136. The method of 135, further comprising electrochemically forming the conductive nodular or nanopillar features, wherein the conductive nodular or nanopillar features comprise copper.
137. The method according to any of embodiments 133-136, wherein forming the surface layer comprises a conversion coating process.
138. The method according to any of embodiments 133-137, wherein forming the surface layer comprises electroplating.
139. The method according to any of embodiments 133-138, wherein the transition metallate compound comprises Sc, Ti, V, Mn, Fe, Co, Ni, Cu, Zn, Y, Zr, Nb, Mo, Ta, or W.
140 The method according to any of embodiments 133-139, wherein the transition metallate compound comprises an oxometallate
141. The method of embodiment 140, wherein the oxometallate comprises a titanate, a vanadate, a molybdate, a tungstate, or a niobate.
142. The method of embodiment 141, wherein the mixture further comprises a phosphate compound.
143. The method of embodiment 142, wherein the mixture further comprises a calcium compound and a zinc compound.
144. The method according to any of embodiments 133-143, wherein the pH of the mixture is in a range of 6 to 8.
145. The method according to any of embodiments 133-143, wherein the pH of the mixture is less than 6.
146. The method according to any of embodiments 133-145, wherein the contacting is performed at a mixture temperature in a range of 15° C. to 25° C.
147. The method according to any of embodiments 133-145, wherein the contacting is performed at a mixture that is greater than 25° C. and less than 65° C.
148. The method according to any of embodiments 133-147, wherein the one or more mixture solvents comprises water at a concentration of at least 50 molar %.
149. The method according to 148, wherein the water concentration is at least 90 molar %.
150. The method according to any of embodiments 133-149, wherein the surface layer comprises a compositional gradient.
151. The method according to any of embodiments 133-150, further comprising rinsing the current collector with a rinse agent after contacting with the mixture, wherein the rinse agent comprises water or an organic solvent.
152. The method of according to any of embodiments 133-151, further comprising pretreating the electrically conductive layer prior to the contacting with the mixture.
153. The method of embodiment 152, wherein the pretreating comprises contacting the electrically conductive layer with an organic solvent.
154. The method of embodiment 153, wherein the organic solvent comprises an alcohol or a ketone.
155. The method according to any of embodiments 152-154, wherein the pretreating comprises contacting the electrically conductive layer with an acid.
156. The method according to any of embodiments 152-155, wherein the pretreating comprises heating the electrically conductive layer to a temperature of at least 100° C.
157. The method according to any of embodiments 152-156, wherein the pretreating removes one or more anticorrosion layers present on the electrically conductive layer prior to contacting with the mixture.
158. The method according to any of embodiments 152-157, wherein the pretreating removes oils or contaminants on the electrically conductive layer.
159. The method according to any of embodiments 152-158, wherein the pretreating modifies the chemical properties of the surface of the electrically conductive layer.
160. The method according to any of embodiments 152-159, wherein the pretreating increases the surface roughness of the electrically conductive layer.
161. The method according to any of embodiments 133-160, wherein the mixture comprises a homogenous solution.
162. The method according to any of embodiments 133-160, wherein the mixture comprises a dispersion or emulsion.
163. The method according to any of embodiments 133-162, wherein the mixture comprises water.
164. The method according to any of embodiments 133-163, wherein the mixture comprises an organic solvent.
165. The method according to any of embodiments 133-164, wherein the contacting is performed for a time period in a range of 1 sec to 60 seconds.
166. The method according to any of embodiments 133-165, further comprising transporting the electrically conductive layer to and through the mixture by roll-to-roll processing.
167. An anode for a lithium-ion energy storage device, the anode comprising a current collector made according to any of embodiments 133-166 and a lithium storage layer disposed over the current collector.
168. The anode of embodiment 167, wherein the lithium storage layer comprises silicon.
169. The anode of embodiment 167 or 168, wherein the lithium storage layer comprises at least 40 atomic % silicon, germanium, or a combination thereof.
170. The anode according to any of embodiments 167-169, wherein the lithium storage layer comprises graphite.
171. The anode according to any of embodiments 167-170, wherein the lithium storage layer further comprises at least 1% by weight of a carbon-based binder.
172. The anode according to any of embodiments 167-169, wherein the lithium storage layer is substantially free of carbon-based binders.
173. The anode of embodiment 172, wherein the lithium storage layer comprises at least 80 atomic % amorphous silicon and has a density in a range of 1.1 to 2.25 g/cm³.
175. The anode of embodiment 172 or 173, wherein the lithium storage layer is a continuous porous lithium storage layer.
175. The anode according to any of embodiments 172-175, wherein the lithium storage layer is deposited over the current collector by a PECVD process.
176. A method of making an anode for use in an energy storage device, the method comprising:
   a) providing a current collector made according to any of embodiments 133-166; and
b) depositing a lithium storage layer onto the surface layer by a vapor deposition process,
wherein the lithium storage layer:
   (i) has an average thickness of at least 1 μm,
   (ii) comprises at least 40 atomic % silicon, germanium, or a combination thereof, and
   (iii) is in contact with the surface layer.
177. The method of embodiment 176, wherein the vapor deposition process is a chemical vapor deposition process.
178. The method of embodiment 176 or 177, wherein the vapor deposition process is a PECVD process.
179. The method of embodiment 178, wherein the PECVD process comprises forming a capacitively-coupled plasma or an inductively-coupled plasma.
180. The method of embodiment 178, wherein the PECVD process comprises a DC plasma source, an AC plasma source, an RF plasma source, a VHF plasma source, or a microwave plasma source.
181. The method of embodiment 178, wherein the PECVD process comprises magnetron-assisted RF PECVD.
182. The method of embodiment 178, wherein the PECVD process comprises expanding thermal plasma chemical vapor deposition.
183. The method of embodiment 178, wherein the PECVD process comprises hollow cathode PECVD.
184. The method according to any of embodiments 177-183, further comprising forming the lithium storage layer using a silane-based precursor gas.
185. The method of embodiment 184, wherein the silane-based precursor gas comprises silane (SiH₄).
186. The method of embodiment 66 or 67, wherein the silane-based precursor gas comprises dichlorosilane (H₂SiCl₂), monochlorosilane (H₃SiCl), trichlorosilane (HSiCl₃), silicon tetrachloride (SiCl₄), disilane, tetrafluorsilane, triethylsilane, or diethylsilane.
187. The method according to any of embodiments 184-186, further comprising adding hydrogen gas during the chemical vapor deposition.
188. The method of embodiment 187, wherein the ratio of the silane-based precursor gas to the hydrogen gas is 2 or less.
189. The method of embodiment 176, wherein the vapor deposition process comprises physical vapor deposition.
190. The method of embodiment 189, wherein the physical vapor deposition comprises sputtering.
191. The method according to any of embodiments 176-190, wherein the lithium storage layer includes less than 5 atomic % carbon.
192. The method according to any of embodiments 176-191, wherein the lithium storage layer is substantially free of high aspect ratio lithium storage nanostructures.
193. The method according to any of embodiments 176-192, wherein the lithium storage layer is a continuous porous lithium storage layer.
194. The method according to any of embodiments 176-193, wherein the lithium storage layer comprises a sub-stoichiometric nitride of silicon.
195. The method according to any of embodiments 176-194, wherein the lithium storage layer comprises a sub-stoichiometric oxide of silicon.
196. The method according to any of embodiments 176-195, wherein the lithium storage layer comprises at least 80 atomic % of amorphous silicon.
197. The method according to any of embodiments 176-195, wherein the lithium storage layer comprises at least 90 atomic % of amorphous silicon.
198. The method of embodiment 196 or 197, wherein the density of the lithium storage layer is in a range of 1.1 to 2.25 g/cm³.
199. The method according to any of embodiments 176-195, wherein the lithium storage layer comprises up to 30% of nano-crystalline silicon.
200. The method according to any of embodiments 176-199, wherein the lithium storage layer comprises columns of silicon nanoparticle aggregates.
201. The method according to any of embodiments 176-200, wherein the lithium storage layer has an average thickness of at least 2.5 μm.
202. The method according to any of embodiments 176-200, wherein the lithium storage layer has an average thickness of at least 5.0 μm.
203. The anode according to any of embodiments 176-200, wherein the lithium storage layer has an average thickness of at least 7.0 μm.
204. The anode according to any of embodiments 176-200, wherein the lithium storage layer has an average thickness in a range of 2.5 μm to 20 μm.
205. The method according to any of embodiments 176-204, further comprising doping the lithium storage layer with boron, phosphorous, carbon, sulfur, fluorine, aluminum, gallium, indium, arsenic, antimony, or bismuth, or a combination thereof.
206. A lithium-ion battery comprising:
a) a cathode;
b) an anode according to any of embodiments 1-57, an anode made according to any of embodiments 58-122, an anode according to any of embodiments or 167-175; or an anode made according to any of embodiments 176-205.
c) an electrolyte in contact with the anode and cathode.
207. The lithium-ion battery of embodiment 206, wherein the anode is prelithiated.
208. The lithium-ion battery of embodiment 206 or 207, wherein the battery is characterized in operation by an initial charge capacity of at least 1.5 mAh/cm² and is capable of an 80% SoH cycle life of at least 100 cycles at a charge rate of at least 1 C and a discharge rate of at least 1 C.
209. The lithium-ion battery of embodiment 208, wherein the cycle life is at least 200 cycles.
210. The lithium-ion battery of embodiment 208 or 209, wherein the initial charge capacity is at least 2.0 mAh/cm².
211. The lithium-ion battery of embodiment 206 or 207, wherein the battery is characterized in operation by an initial charge capacity of at least 1.5 mAh/cm² and is capable of an 80% SoH cycle life of at least 300 cycles at a charge rate of at least 3 C and a discharge rate of at least C/3.
212. The lithium-ion battery according to any of embodiments 206-211, wherein the cathode comprises NMC, LCO, LFP, LNMO, LMO, or NCA.
213. The lithium-ion battery according to any of embodiments 206-211, wherein the cathode comprises sulfur, selenium, or both sulfur and selenium.
214. The lithium-ion battery according to any of embodiments 206-213, further comprising a separator disposed between the anode and cathode, wherein the electrolyte is a liquid.
215. The lithium-ion battery according to any of embodiments 206-214, wherein the electrolyte is a gel.
216. The lithium-ion battery according to any of embodiments 206-213, wherein the electrolyte is a solid.
217. The lithium-ion battery according to embodiment 216, wherein the electrolyte comprises a solid polymer.
218. A lithium-ion battery comprising an anode and a cathode, wherein the anode is prepared in part by applying at least one electrochemical charge/discharge cycle to a non-cycled anode, the non-cycled anode comprising an anode according to any of embodiments 1- 57, an anode made according to any of embodiments 58-122, an anode according to any of embodiments or 167-175; or an anode made according to any of embodiments 176-205.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the anode” includes reference to one or more anodes and equivalents thereof known to those skilled in the art, and so forth. The invention has now been described in detail for the purposes of clarity and understanding. However, it will be appreciated that certain changes and modifications may be practice within the scope of the appended claims.

All publications, patents, and patent applications cited herein are hereby incorporated by reference in their entirety for all purposes. None is admitted to be prior art.

1. An anode for an energy storage device, the anode comprising:
a) a current collector comprising an electrically conductive layer and a surface layer disposed over and in contact with the electrically conductive layer, wherein the surface layer comprises a transition metallate other than chromate; and
b) a lithium storage layer overlaying and in contact with the surface layer,
wherein the lithium storage layer:
(i) has an average thickness of at least 1 μm,
(ii) comprises at least 40 atomic % silicon, germanium, or a combination thereof, and
(iii) is substantially free of carbon-based binders.

2. The anode of claim 1, wherein the current collector is characterized by a surface roughness Rₐ≥250 nm.

3. The anode of claim 1, where in the transition metallate comprises Sc, Ti, V, Mn, Fe, Co, Ni, Cu, Y, Zr, Nb, Mo, Ta, or W.

4. The anode of claim 1, wherein the surface layer further comprises chromium.

5. The anode of claim 1, wherein the transition metallate comprises an oxometallate.

6. The anode of claim 5, wherein the oxometallate comprises a titanate, a vanadate, a molybdate, a tungstate, or a niobate.

7. The anode of claim 6, wherein the surface layer comprises a molybdate and phosphorous.

8. The anode of claim 7, wherein the phosphorous is in the form of phosphate.

9. The anode of claim 7, wherein the surface layer further comprises calcium and zinc.

10. (canceled)

11. The anode of claim 1, wherein the electrically conductive layer comprises a plurality of electrically conductive nodular or nanopillar features and the surface layer is provided at least partially over the nodular or nanopillar features.

12-18. (canceled)

19. The anode of claim 1, wherein the electrically conductive layer comprises copper, nickel, or titanium.

20-25. (canceled)

26. The anode of claim 1, wherein the electrically conductive layer comprises a mesh of electrically conductive carbon.

27. The anode of claim 26, wherein the electrically conductive layer further comprises a metal interlayer interposed between the mesh of electrically conductive carbon and the surface layer.

28-30. (canceled)

31. The anode of claim 1, wherein the electrically conductive layer or current collector is characterized by a tensile strength of at least 600 Mpa.

32-33. (canceled)

34. The anode of claim 1, wherein the lithium storage layer is substantially free of lithium storage nanostructures with an aspect ratio greater than 4:1.

35. The anode of claim 1, wherein the lithium storage layer is a continuous porous lithium storage layer.

36-37. (canceled)

38. The anode of claim 1, wherein the lithium storage layer comprises at least 80 atomic % of amorphous silicon.

39. (canceled)

40. The anode of claim 38, wherein the density of the lithium storage layer is in a range of 1.1 to 2.25 g/cm³.

41-43. (canceled)

44. The anode of claim 1, wherein the lithium storage layer further comprises a transition metal distributed through at least a portion of the lithium storage layer, and the transition metal comprised in the lithium storage layer is present at a total concentration in a range of 0.5 to 5.0 atomic %.

45-50. (canceled)

51. The anode of claim 1, wherein the lithium storage layer has an average thickness in a range of 2.5 μm to 20 μm.

52-57. (canceled)
